(19) United States
(12) Patent Application Publication
(10) Pub. No.: US 2014/0233660 A1
(43) Pub. Date: Aug. 21, 2014

(54) IMAGE PROCESSING DEVICE AND METHOD

(71) Applicant: SONY CORPORATION, Minato-ku, Tokyo (JP)

(72) Inventor: Kazushi Sato, Kanagawa (JP)

(73) Assignee: SONY CORPORATION, Minato-ku, Tokyo (JP)

(21) Appl. No.: 14/346,888

(22) PCT Filed: Oct. 18, 2012
(86) PCT No.: PCT/JP2012/076885

§ 371 Date: Mar. 24, 2014

(30) Foreign Application Priority Data
Oct. 27, 2011 (JP) 2011-235881

(51) Int. Cl. H04N 19/80

(52) U.S. Cl. CPC H04N 19/0089
USPC 375/240.29

(57) ABSTRACT

The present disclosure relates to image processing devices and methods for more appropriate removal of block distortion and improvement of decoded image quality.

Based on information about a quad-tree structure from an adaptive offset unit, a deblocking filter control unit determines whether the current region in a deblocking filtering process is at a boundary of the current region in an adaptive offset process. If the current region in the deblocking filtering process is at a boundary of the current region in the adaptive offset process, the deblocking filter control unit supplies control information for increasing the filtering strength to a deblocking filter. The present disclosure can be applied to image processing devices, for example.

### TECHNICAL FIELD

The present disclosure relates to image processing devices and methods, and more particularly, relates to an image processing device and a method that are designed to increase decoded image quality.

### BACKGROUND ART

In recent years, apparatuses that compress images by implementing an encoding method for compressing image information through orthogonal transforms such as discrete cosine transforms and motion compensation by using redundancy inherent to image information, have been spreading so as to handle image information as digital information and achieve high-efficiency information transmission and accumulation in doing do. This encoding method may be MPEG (Moving Picture Experts Group), for example.

Particularly, MPEG2 (ISO/IEC 13818-2) is defined as a general-purpose image encoding standard, and is applicable to interlaced images and non-interlaced images, and to standard-resolution images and high-definition images. MPEG2 is currently used in a wide range of applications for professionals and general consumers, for example. By using the MPEG2 compression method, a bit rate of 4 to 8 Mbps is assigned to a standard-resolution interlaced image having 720×480 pixels, for example. Also, by using the MPEG2 compression method, a bit rate of 18 to 22 Mbps is assigned to a high-resolution interlaced image having 1920×1088 pixels, for example. In this manner, a high compression rate and excellent image quality can be realized.

MPEG2 is designed mainly for high-quality image encoding suited for broadcasting, but is not compatible with lower bit rates than MPEG1 or encoding methods involving higher compression rates. As mobile terminals are becoming popular, the demand for such encoding methods is expected to increase in the future, and to meet the demand, the MPEG4 encoding method was standardized. As for an image encoding method, the ISO/IEC 14496-2 standard was approved as an international standard in December 1998.

On the standardization schedule, the standard was approved as an international standard under the name of H.264 and MPEG-4 Part 10 (Advanced Video Coding, hereinafter referred to as H.264/AVC) in March 2003.

As an extension of H.264/AVC, FRExt (Fidelity Range Extension) was standardized in February 2005. FRExt includes coding tools for business use, such as RGB, 4:2:2, and 4:4:4, and the 8×8 DCT and quantization matrix specified in MPEG-2. As a result, an encoding method for enabling excellent presentation of movies containing film noise was realized by using H.264/AVC, and the encoding method is now used in a wide range of applications such as Blu-ray Disc (a trade name).

However, there is an increasing demand for encoding at a higher compression rate so as to compress images having a resolution of about 4000×2000 pixels, which is four times higher than the high-definition image resolution, or distribute high-definition images in today's circumstances where transmission capacities are limited as in the Internet. Therefore, studies on improvement in encoding efficiency are still continued by VCEG (Video Coding Expert Group) under ITU-T.

As one of the techniques for increasing encoding efficiency, incorporating a FIR filter in the motion compensation loop has been suggested (see Non-Patent Document 1, for example). In an encoding device, the FIR filter coefficient is determined with a Wiener Filter so as to minimi ze an error in relation to an input image. In this manner, degradation in the reference image can be minimized, and the efficiency in encoding compressed image information to be output can be increased.

At present, to achieve higher encoding efficiency than that of H.264/AVC, an encoding method called HEVC (High Efficiency Video Coding) is being developed as a standard by JCTVC (Joint Collaboration Team-Video Coding), which is a joint standards organization of ITU-T and ISO/IEC (see Non-Patent Document 2, for example).

According to HEVC, coding units (CUs) are defined as units of processing like macroblocks of AVC. Unlike the macroblocks of AVC, the CUs are not fixed to the size of 16×16 pixels. The size of the CUs is specified in the compressed image information in each sequence.

The CUs form a hierarchical structure including the largest coding units (LCUs) and the smallest coding units (SCUs). Roughly speaking, the LCUs can be considered equivalent to the macroblocks of AVC, and the CUs on the lower hierarchical levels than the LCUs (the CUs smaller than the LCUs) can be considered equivalent to the sub macroblocks of AVC.

According to HEVC, a method using an adaptive offset filter suggested in Non-Patent Document 3 is adopted. According to HEVC, an adaptive offset filter is placed between a deblocking filter and an adaptive loop filter.

As for adaptive offset types, there are two “band offset” types and six “edge offset” types. It is also possible to use no offsets. An image may be divided according to “quad-tree”, and one of the above described adaptive offset types can be selected for encoding in each of the divisional regions. By using this method, encoding efficiency can be increased.

### Citation List

### Non-Patent Documents

Non-Patent Document 1: Takeshi Chujoh, Goki Yasuda, Naofumi Wada, Takashi Watanabe, Tomoo Yamakage, “Block-based Adaptive Loop Filter”, VCEG-AI18, ITU-Telecommunications Standardization SectorSTUDY GROUP 16 Question 6 Video Coding Experts Group (VCEG) 35th Meeting: Berlin, Germany, 16-18 Jul. 2008
Non-Patent Document 2: Thomas Wiegand, Woo-Jin Han, Benjamin Bross, Jens-Rainer Ohm, Gary J. Sullivan, “Working Draft 4 of High-Efficiency Video Coding”, JCTVC-F803, Joint Collaborative Team on Video Coding (JCT-VC) of ITU-T SG16 WP3 and ISO/IEC JTC1/SC29/WG11 6th Meeting: Torino, IT, 14-22 Jul. 2011
Non-Patent Document 3: Chih-Ming Fu, Ching-Yeh Chen, Yu-Wen Huang, Shawmin Lei, “CE8 Subtest 3:Picture Quality Adaptive Offset”, JCTVC-D122, Joint Collaborative Team on Video Coding (JCT-VC) of ITU-T SG16 WP3 and ISO/IEC JTC1/SC29/WG11 4th Meeting: Daegu, KR, 20-28 Jan. 2011

### SUMMARY OF THE INVENTION

### Problems to be Solved by the Invention

However, the method suggested in Non-Patent Document 3 is implemented on a block basis. When such a block-based process is performed after a deblocking filtering process, block distortion might occur.

The present disclosure is made in view of those circumstances, and is to remove block distortion more appropriately and increase decoded image quality.

### Solutions to Problems

An image processing device of one aspect of the present disclosure includes: a decoding unit that decodes an encoded stream to generate an image; an adaptive offset processing unit that performs an adaptive offset process on the image generated by the decoding unit; a deblocking filter adjustment unit that adjusts the strength of a deblocking filtering process when the current region in the deblocking filtering process in the image is determined to be at a boundary of the current region in the adaptive offset process based on information about the quad-tree structure used in the adaptive offset process; and a deblocking filtering unit that performs the deblocking filtering process on the image subjected to the adaptive offset process by the adaptive offset processing unit, the deblocking filtering process having the strength adjusted by the deblocking filter adjustment unit.

The deblocking filter adjustment unit may adjust the strength of the deblocking filtering process, when the current region in the deblocking filtering process and a neighboring region adjacent to the current region in the deblocking filtering process are at a boundary of the current region in the adaptive offset process, and the current region in the deblocking filtering process and the neighboring region are processed with offsets of different types among edge offsets, band offsets, and “no offset”.

The deblocking filter adjustment unit may adjust the strength of the deblocking filtering process, when the current region in the deblocking filtering process and a neighboring region adjacent to the current region in the deblocking filtering process are at a boundary of the current region in the adaptive offset process, and are processed with offsets of the same type and under different categories, the type of the offsets being an edge offset or a band offset.

The deblocking filter adjustment unit may adjust the strength of the deblocking filtering process with a boundary strength value.

The deblocking filter adjustment unit may adjust the strength of the deblocking filtering process by incrementing the boundary strength value by +1, when the current region in the deblocking filtering process and the neighboring region are at a boundary of the current region in the adaptive offset process and are processed with offsets of different types.

The deblocking filter adjustment unit may adjust the strength of the deblocking filtering process by adjusting the boundary strength value to 4, when the current region in the deblocking filtering process and the neighboring region are at a boundary of the current region in the adaptive offset process and are processed with offsets of different types.

The deblocking filter adjustment unit may adjust the strength of the deblocking filtering process with a value a or a value β, when the current region in the deblocking filtering process and the neighboring region are at a boundary of the current region in the adaptive offset process and are processed with offsets of different types.

The deblocking filter adjustment unit may determine the value α or the value β by performing table reduction using a value obtained by adding a quantization parameter QP and a predetermined value ΔQP, when the current region in the deblocking filtering process and the neighboring region are at a boundary of the current region in the adaptive offset process and are processed with offsets of different types.

An image processing method of the one aspect of the present disclosure includes: generating an image by decoding an encoded stream; performing an adaptive offset process on the generated image; adjusting the strength of a deblocking filtering process when the current region in the deblocking filtering process in the image is determined to be at a boundary of the current region in the adaptive offset process based on information about the quad-tree structure used in the adaptive offset process; and performing the deblocking filtering process on the image subj ected to the adaptive offset process, the deblocking filtering process having the adjusted strength.

An image processing device of another aspect of the present disclosure includes: an adaptive offset processing unit that performs an adaptive offset process on an image that is locally decoded at a time of image encoding; a deblocking filter adjustment unit that adjusts the strength of a deblocking filtering process when the current region in the deblocking filtering process in the image is determined to be at a boundary of the current region in the adaptive offset process based on information about the quad-tree structure used in the adaptive offset process; a deblocking filtering unit that performs the deblocking filtering process on the image subjected to the adaptive offset process by the adaptive offset processing unit, the deblocking filtering process having the strength adjusted by the deblocking filter adjustment unit; and an encoding unit that encodes the image by using the image subjected to the deblocking filtering process by the deblocking filtering unit.

The deblocking filter adjustment unit may adjust the strength of the deblocking filtering process, when the current region in the deblocking filtering process and a neighboring region adjacent to the current region in the deblocking filtering process are at a boundary of the current region in the adaptive offset process, and the current region in the deblocking filtering process and the neighboring region are processed with offsets of different types among edge offsets, band offsets, and “no offset”.

The deblocking filter adjustment unit may adjust the strength of the deblocking filtering process, when the current region in the deblocking filtering process and a neighboring region adjacent to the current region in the deblocking filtering process are at a boundary of the current region in the adaptive offset process, and are processed with offsets of the same type and under different categories, the type of the offsets being an edge offset or a band offset.

The deblocking filter adjustment unit may adjust the strength of the deblocking filtering process with a boundary strength value.

The deblocking filter adjustment unit may adjust the strength of the deblocking filtering process by incrementing the boundary strength value by +1, when the current region in the deblocking filtering process and the neighboring region are at a boundary of the current region in the adaptive offset process and are processed with offsets of different types.

The deblocking filter adjustment unit may adjust the strength of the deblocking filtering process by adjusting the boundary strength value to 4, when the current region in the deblocking filtering process and the neighboring region are at a boundary of the current region in the adaptive offset process and are processed with offsets of different types.

The deblocking filter adjustment unit may adjust the strength of the deblocking filtering process with a value α or a value β, when the current region in the deblocking filtering process and the neighboring region are at a boundary of the current region in the adaptive offset process and are processed with offsets of different types.

The deblocking filter adjustment unit may determine the value α or the value β by performing table reduction using a value obtained by adding a quantization parameter QP and a predetermined value ΔQP, when the current region in the deblocking filtering process and the neighboring region are at a boundary of the current region in the adaptive offset process and are processed with offsets of different types.

An image processing method of the other aspect of the present disclosure includes: performing an adaptive offset process on an image that is locally decoded at a time of image encoding; adjusting the strength of a deblocking filtering process when the current region in the deblocking filtering process in the image is determined to be at a boundary of the current region in the adaptive offset process based on information about the quad-tree structure used in the adaptive offset process; performing the deblocking filtering process on the image subjected to the adaptive offset process, the deblocking filtering process having the adjusted strength; and encoding the image by using the image subjected to the deblocking filtering process, an image processing device performing the adaptive offset process, adjusting the strength of the deblocking filtering process, performing the deblocking filtering process, and encoding the image.

In one aspect of the present disclosure, an image is generated by decoding an encoded stream, and an adaptive offset process is performed on the generated image. When the current region in a deblocking filtering process in the image is determined to be at a boundary of the current region in the adaptive offset process based on information about the quad-tree structure used in the adaptive offset process, the strength of the deblocking filtering process is adjusted, and the deblocking filtering process with the adjusted strength is performed on the image subjected to the adaptive offset process.

In the other aspect of the present disclosure, an adaptive offset process is performed on an image that is locally decoded at a time of image encoding. When the current region in the deblocking filtering process in the image is determined to be at a boundary of the current region in the adaptive offset process based on information about the quad-tree structure used in the adaptive offset process, the strength of the deblocking filtering process is adjusted. The deblocking filtering process with the adjusted strength is then performed on the image subjected to the adaptive offset process, and the image is encoded by using the image subjected to the deblocking filtering process.

Each of the above described image processing devices may be an independent device, or may be an internal block in an image encoding device or an image decoding device.

### Effects of the Invention

According to one aspect of the present disclosure, images can be decoded. Particularly, block distortion can be removed more appropriately, and decoded image quality can be increased.

According to another aspect of the present disclosure, images can be encoded. Particularly, block distortion can be removed more appropriately, and decoded image quality can be increased.

### BRIEF DESCRIPTION OF DRAWINGS

FIG. 1 is a block diagram showing a typical example structure of an image encoding device compliant with H.264/AVC.

FIG. 2 is a block diagram showing a typical example structure of an image decoding device compliant with H.64/AVC.

FIG. 3 is a block diagram showing a typical example structure of an image encoding device using an adaptive loop filter.

FIG. 4 is a block diagram showing a typical example structure of an image decoding device using an adaptive loop filter.

FIG. 5 is a diagram for explaining the operating principles of the deblocking filter.

FIG. 6 is a diagram for explaining a method of defining Bs.

FIG. 7 is a diagram for explaining the operating principles of the deblocking filter.

FIG. 8 is a diagram showing an example of correspondence relationships between indexA and indexB, and values of α and β.

FIG. 9 is a diagram showing an example of correspondence relationships among Bs, indexA, and tC0.

FIG. 10 is a diagram for explaining example structures of Coding Units.

FIG. 11 is a diagram for explaining an adaptive offset process according to HEVC.

FIG. 12 is a diagram for explaining a quad-tree structure.

FIG. 13 is a diagram for explaining band offsets.

FIG. 14 is a diagram for explaining edge offsets.

FIG. 15 is a diagram showing edge offset rule lists.

FIG. 16 is a block diagram showing a typical example structure of an image encoding device of the present disclosure.

FIG. 17 is a diagram showing example structures of the adaptive offset unit and the deblocking filter.

FIG. 18 is a flowchart for explaining an example flow of an encoding process.

FIG. 19 is a flowchart for explaining an example flow of an in-loop filtering process.

FIG. 20 is a flowchart for explaining an example flow of an adaptive offset process.

FIG. 21 is a block diagram showing a typical example structure of an image decoding device.

FIG. 22 is a block diagram showing example structures of the adaptive offset unit and the deblocking filter.

FIG. 23 is a flowchart for explaining an example flow of a decoding process.

FIG. 24 is a flowchart for explaining an example flow of an in-loop filtering process.

FIG. 25 is a flowchart for explaining an example flow of an adaptive offset process.

FIG. 26 is a block diagram showing a typical example structure of a computer.

FIG. 27 is a block diagram schematically showing an example structure of a television apparatus.

FIG. 28 is a block diagram schematically showing an example structure of a portable telephone device.

FIG. 29 is a block diagram schematically showing an example structure of a recording/reproducing apparatus.

FIG. 30 is a block diagram schematically showing an example structure of an imaging apparatus.

### MODES FOR CARRYING OUT THE INVENTION

Modes for carrying out the present disclosure (hereinafter referred to as the embodiments) will be described below. Explanation will be made in the following order.

### 1. Description of Conventional Methods

### 2. First Embodiment (Image Encoding Device)

### 3. Second Embodiment (Image Decoding Device)

### 4. Third Embodiment (Personal Computer)

### 5. Example Applications

### 1. FIRST EMBODIMENT

[Image Encoding Device Compliant with H.264/AVC]

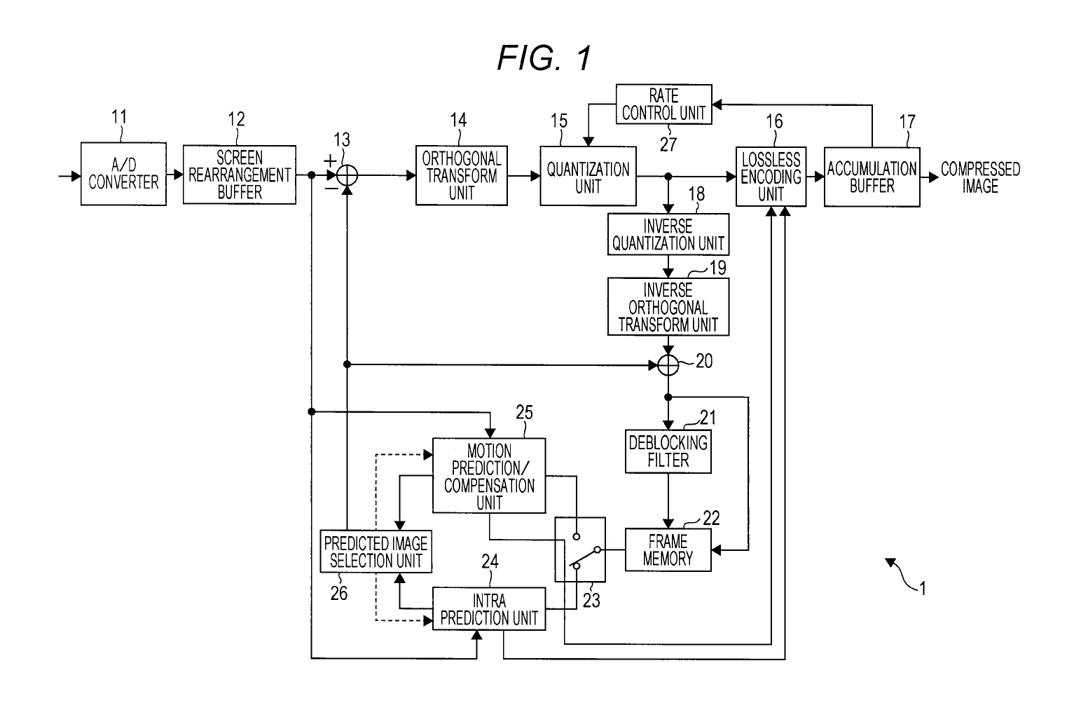

FIG. 1 shows the structure of an embodiment of an image encoding device that encodes images by the H.264 and MPEG (Moving Picture Experts Group) 4 Part 10 (AVC (Advanced Video Coding)) encoding method. Hereinafter, the H.264 and MPEG encoding method will be referred to simply as H.264/AVC.

In the example shown in FIG. 1, the image encoding device 1 is designed to include an A/D converter 11, a screen rearrangement buffer 12, an arithmetic operation unit 13, an orthogonal transform unit 14, a quantization unit 15, a lossless encoding unit 16, an accumulation buffer 17, an inverse quantization unit 18, an inverse orthogonal transform unit 19, and an arithmetic operation unit 20. The image encoding device 1 is also designed to include a deblocking filter 21, a frame memory 22, a selection unit 23, an intra prediction unit 24, a motion prediction/compensation unit 25, a predicted image selection unit 26, and a rate control unit 27.

The A/D converter 11 performs an A/D conversion on input image data, outputs the image data to the screen rearrangement buffer 12, and stores the image data therein. The screen rearrangement buffer 12 rearranges the image frames stored in displaying order in accordance with the GOP (Group of Pictures) structure, so that the frames are arranged in encoding order. The screen rearrangement buffer 12 supplies the image having the rearranged frame order to the arithmetic operation unit 13. The screen rearrangement buffer 12 also supplies the image having the rearranged frame order to the intra prediction unit 24 and the motion prediction/compensation unit 25.

The arithmetic operation unit 13 subtracts a predicted image supplied from the intra prediction unit 24 or the motion prediction/compensation unit 25 via the predicted image selection unit 26, from the image read from the screen rearrangement buffer 12, and outputs the difference information to the orthogonal transform unit 14.

When intra encoding is performed on an image, for example, the arithmetic operation unit 13 subtracts a predicted image supplied from the intra prediction unit 24, from the image read from the screen rearrangement buffer 12. When inter encoding is performed on an image, for example, the arithmetic operation unit 13 subtracts a predicted image supplied from the motion prediction/compensation unit 25, from the image read from the screen rearrangement buffer 12.

The orthogonal transform unit 14 performs an orthogonal transform, such as a discrete cosine transform or a Karhunen-Loeve transform, on the difference information supplied from the arithmetic operation unit 13, and supplies the transform coefficient to the quantization unit 15.

The quantization unit 15 quantizes the transform coefficient output from the orthogonal transform unit 14. Based on target bit rate information supplied from the rate control unit 27, the quantization unit 15 sets a quantization parameter, and performs quantization. The quantization unit 15 supplies the quantized transform coefficient to the lossless encoding unit 16.

The lossless encoding unit 16 performs lossless encoding, such as variable-length encoding or arithmetic encoding, on the quantized transform coefficient. Since the coefficient data has already been quantized under the control of the rate control unit 27, the bit rate is equal to the target value (or approximates the target value) set by the rate control unit 27.

The lossless encoding unit 16 obtains information indicating an intra prediction and the like from the intra prediction unit 24, and obtains information indicating an inter prediction mode, motion vector information, and the like from the motion prediction/compensation unit 25. The information indicating an intra prediction (an intra-screen prediction) will be hereinafter also referred to as intra prediction mode information. The information indicating an inter prediction (an inter-screen prediction) will be hereinafter referred to as inter prediction mode information.

The lossless encoding unit 16 not only encodes the quantized transform coefficient, but also incorporates (multiplexes) various kinds of information such as a filter coefficient, the intra prediction mode information, the inter prediction mode information, and the quantization parameter, into the header information in encoded data. The lossless encoding unit 16 supplies and stores the encoded data obtained through the encoding into the accumulation buffer 17.

For example, in the lossless encoding unit 16, a lossless encoding process such as variable-length encoding or arithmetic encoding is performed. The variable-length encoding may be CAVLC (Context-Adaptive Variable Length Coding) specified by H.264/AVC, for example. The arithmetic encoding may be CABAC (Context-Adaptive Binary Arithmetic Coding) or the like.

The accumulation buffer 17 temporarily holds the encoded data supplied from the lossless encoding unit 16. The accumulation buffer 17 outputs the accumulated encoded data as an encoded image that is encoded by H.264/AVC, to a recording device or a transmission path (not shown) in a later stage at a predetermined time, for example. That is, the accumulation buffer 17 also serves as a transmission unit that transmits encoded data.

The transform coefficient quantized at the quantization unit 15 is also supplied to the inverse quantization unit 18. The inverse quantization unit 18 inversely quantizes the quantized transform coefficient by a method compatible with the quantization performed by the quantization unit 15. The inverse quantization unit 18 supplies the obtained transform coefficient to the inverse orthogonal transform unit 19.

The inverse orthogonal transform unit 19 performs an inverse orthogonal transform on the supplied transform coefficient by a method compatible with the orthogonal transform process performed by the orthogonal transform unit 14. The output subjected to the inverse orthogonal transform (the restored difference information) is supplied to the arithmetic operation unit 20.

The arithmetic operation unit 20 obtains a locally decoded image (a decoded image) by adding the predicted image supplied from the intra prediction unit 24 or the motion prediction/compensation unit 25 via the predicted image selection unit 26 to the inverse orthogonal transform result supplied from the inverse orthogonal transform unit 19 or the restored difference information.

For example, when the difference information corresponds to an image to be intra-encoded, the arithmetic operation unit 20 adds the predicted image supplied from the intra prediction unit 24 to the difference information. When the difference information corresponds to an image to be inter-encoded, the arithmetic operation unit 20 adds the predicted image supplied from the motion prediction/compensation unit 25 to the difference information, for example.

The addition result is supplied to the deblocking filter 21 or the frame memory 22.

The deblocking filter 21 removes block distortion from the decoded image by performing a deblocking filtering process where necessary. The deblocking filter 21 supplies the filtering process result to the frame memory 22. The decoded image that is output from the arithmetic operation unit 20 can be supplied to the frame memory 22 without passing through the deblocking filter 21. That is, the deblocking filtering process by the deblocking filter 21 can be skipped.

The frame memory 22 stores the supplied decoded image, and outputs the stored decoded image as a reference image to the intra prediction unit 24 or the motion prediction/compensation unit 25 via the selection unit 23 at a predetermined time.

When intra encoding is performed on an image, for example, the frame memory 22 supplies the reference image to the intra prediction unit 24 via the selection unit 23. When inter encoding is performed on an image, for example, the frame memory 22 supplies the reference image to the motion prediction/compensation unit 25 via the selection unit 23.

When the reference image supplied from the frame memory 22 is an image to be subjected to intra encoding, the selection unit 23 supplies the reference image to the intra prediction unit 24. When the reference image supplied from the frame memory 22 is an image to be subjected to inter encoding, the selection unit 23 supplies the reference image to the motion prediction/compensation unit 25.

The intra prediction unit 24 performs intra predictions (intra-screen predictions) to generate a predicted image by using the pixel values in the current picture supplied from the frame memory 22 via the selection unit 23. The intra prediction unit 24 performs intra predictions in more than one mode (intra prediction modes) that is prepared in advance.

According to H.264/AVC, an intra 4×4 prediction mode, an intra 8×8 prediction mode, and an intra 16×16 prediction mode are defined for luminance signals. As for chrominance signals, a prediction mode independent of luminance signals can be defined for each macroblock. In the intra 4×4 prediction mode, one intra prediction mode is defined for each 4×4 luminance block. In the intra 8×8 prediction mode, one intra prediction mode is defined for each 8×8 luminance block. In the intra 16×16 prediction mode and for the chrominance signals, one prediction mode is defined for each macroblock.

The intra prediction unit 24 generates predicted images in all the candidate intra prediction modes, evaluates the cost function values of the respective predicted images by using the input image supplied from the screen rearrangement buffer 12, and selects an optimum mode. After selecting the optimum intra prediction mode, the intra prediction unit 24 supplies the predicted image generated in the optimum mode to the arithmetic operation unit 13 and the arithmetic operation unit 20 via the predicted image selection unit 26.

As described above, the intra prediction unit 24 also supplies information such as the intra prediction mode information indicating the adopted intra prediction mode to the lossless encoding unit 16 where appropriate.

Using the input image supplied from the screen rearrangement buffer 12, and the reference image supplied from the frame memory 22 via the selection unit 23, the motion prediction/compensation unit 25 performs motion predictions (inter predictions) on an image to be subjected to inter encoding. The motion prediction/compensation unit 25 performs a motion compensation process in accordance with the detected motion vectors, to generate a predicted image (inter predicted image information). The motion prediction/compensation unit 25 performs such inter predictions in more than one mode (inter prediction mode) that is prepared in advance.

The motion prediction/compensation unit 25 generates predicted images in all the candidate inter prediction modes, evaluates the cost function values of the respective predicted images, and selects an optimum mode. The motion prediction/compensation unit 25 supplies the generated predicted image to the arithmetic operation unit 13 and the arithmetic operation unit 20 via the predicted image selection unit 26.

The motion prediction/compensation unit 25 supplies the inter prediction mode information indicating the adopted inter prediction mode, and motion vector information indicating the calculated motion vectors to the lossless encoding unit 16.

When intra encoding is performed on an image, the predicted image selection unit 26 supplies the output of the intra prediction unit 24 to the arithmetic operation unit 13 and the arithmetic operation unit 20. When inter encoding is performed on an image, the predicted image selection unit 26 supplies the output of the motion prediction/compensation unit 25 to the arithmetic operation unit 13 and the arithmetic operation unit 20.

Based on the compressed image stored in the accumulation buffer 17, the rate control unit 27 controls the quantization operation rate of the quantization unit 15 so as not to cause an overflow or underflow.

[Image Decoding Device Compliant with H.264/AVC]

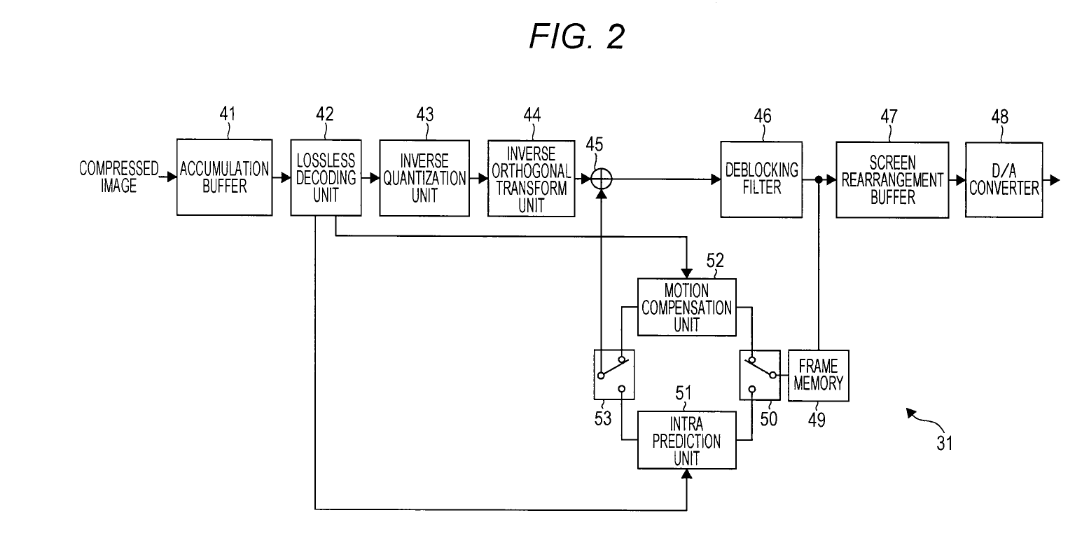

FIG. 2 is a block diagram showing a typical example structure of an image decoding device that realizes image compression through orthogonal transforms, such as discrete cosine transforms or Karhunen-Loeve transforms, and motion compensation. The image decoding device 31 shown in FIG. 2 is a decoding device that is compatible with the image encoding device 1 shown in FIG. 1.

Data encoded by the image encoding device 1 is supplied to the image decoding device 31 compatible with the image encoding device 1 via a passage such as a transmission path or a recording medium, and is then decoded.

As shown in FIG. 2, the image decoding device 31 is designed to include an accumulation buffer 41, a lossless decoding unit 42, an inverse quantization unit 43, an inverse orthogonal transform unit 44, an arithmetic operation unit 45, a deblocking filter 46, a screen rearrangement buffer 47, and a D/A converter 48. The image decoding device 31 also includes a frame memory 49, a selection unit 50, an intra prediction unit 51, a motion compensation unit 52, and an image selection unit 53.

The accumulation buffer 41 receives and accumulates transmitted encoded data. That is, the accumulation buffer 41 also serves as a reception unit that receives transmitted encoded data. The encoded data has been encoded by the image encoding device 1. The lossless decoding unit 42 decodes the encoded data read from the accumulation buffer 41 at a predetermined time, by a method compatible with the encoding method used by the lossless encoding unit 16 shown in FIG. 1.

When the current frame is an intra-encoded frame, the header portion of the encoded data stores intra prediction mode information. The lossless decoding unit 42 also decodes the intra prediction mode information, and supplies the resultant information to the intra prediction unit 51. When the current frame is an inter-encoded frame, on the other hand, the header portion of the encoded data stores motion vector information. The lossless decoding unit 42 also decodes the motion vector information, and supplies the resultant information to the motion compensation unit 52.

The inverse quantization unit 43 inversely quantizes the coefficient data (the quantized coefficient) decoded by the lossless decoding unit 42, by a method compatible with the quantization method used by the quantization unit 15 shown in FIG. 1. That is, the inverse quantization unit 43 inversely quantizes the quantized coefficient by the same method as the method used by the inverse quantization unit 18 shown in FIG. 1.

The inverse quantization unit 43 supplies the inversely-quantized coefficient data, or an orthogonal transform coefficient, to the inverse orthogonal transform unit 44. The inverse orthogonal transform unit 44 subjects the orthogonal transform coefficient to an inverse orthogonal transform by a method compatible with the orthogonal transform method used by the orthogonal transform unit 14 shown in FIG. 1 (the same method as the method used by the inverse orthogonal transform unit 19 shown in FIG. 1), and obtains decoded residual error data corresponding to the residual error data from the time prior to the orthogonal transform performed by the image encoding device 1. For example, a fourth-order inverse orthogonal transform is performed.

The decoded residual error data obtained through the inverse orthogonal transform is supplied to the arithmetic operation unit 45. A predicted image is also supplied to the arithmetic operation unit 45 from the intra prediction unit 51 or the motion compensation unit 52 via the image selection unit 53.

The arithmetic operation unit 45 adds the decoded residual error data to the predicted image, and obtains decoded image data corresponding to the image data from the time prior to the predicted image subtraction performed by the arithmetic operation unit 13 of the image encoding device 1. The arithmetic operation unit 45 supplies the decoded image data to the deblocking filter 46.

The deblocking filter 46 removes block distortion from the supplied decoded image, and supplies the image to the screen rearrangement buffer 47.

The screen rearrangement buffer 47 performs image rearrangement. Specifically, the frame sequence rearranged in the encoding order by the screen rearrangement buffer 12 shown in FIG. 1 is rearranged in the original displaying order. The D/A converter 48 performs a D/A conversion on the image supplied from the screen rearrangement buffer 47, and outputs the converted image to a display (not shown) to display the image.

The output of the deblocking filter 46 is further supplied to the frame memory 49.

The frame memory 49, the selection unit 50, the intra prediction unit 51, the motion compensation unit 52, and the image selection unit 53 are equivalent to the frame memory 22, the selection unit 23, the intra prediction unit 24, the motion prediction/compensation unit 25, and the predicted image selection unit 26 of the image encoding device 1, respectively.

The selection unit 50 reads, from the frame memory 49, an image to be inter-processed and an image to be referred to, and supplies the images to the motion compensation unit 52. The selection unit 50 also reads an image to be used for intra predictions from the frame memory 49, and supplies the image to the intra prediction unit 51.

Information that has been obtained by decoding the header information and indicates an intra prediction mode or the like is supplied, where appropriate, from the lossless decoding unit 42 to the intra prediction unit 51. Based on the information, the intra prediction unit 51 generates a predicted image from the reference image obtained from the frame memory 49, and supplies the generated predicted image to the image selection unit 53.

The motion compensation unit 52 obtains the information obtained by decoding the header information (prediction mode information, motion vector information, reference frame information, a flag, respective parameters, and the like), from the lossless decoding unit 42.

Based on the information supplied from the lossless decoding unit 42, the motion compensation unit 52 generates a predicted image from the reference image obtained from the frame memory 49, and supplies the generated predicted image to the image selection unit 53.

The image selection unit 53 selects the predicted image generated by the motion compensation unit 52 or the intra prediction unit 51, and supplies the predicted image to the arithmetic operation unit 45.

[Details of an Adaptive Loop Filter]

Next, the adaptive loop filter (ALF) suggested in Non-Patent Document 1 is described.

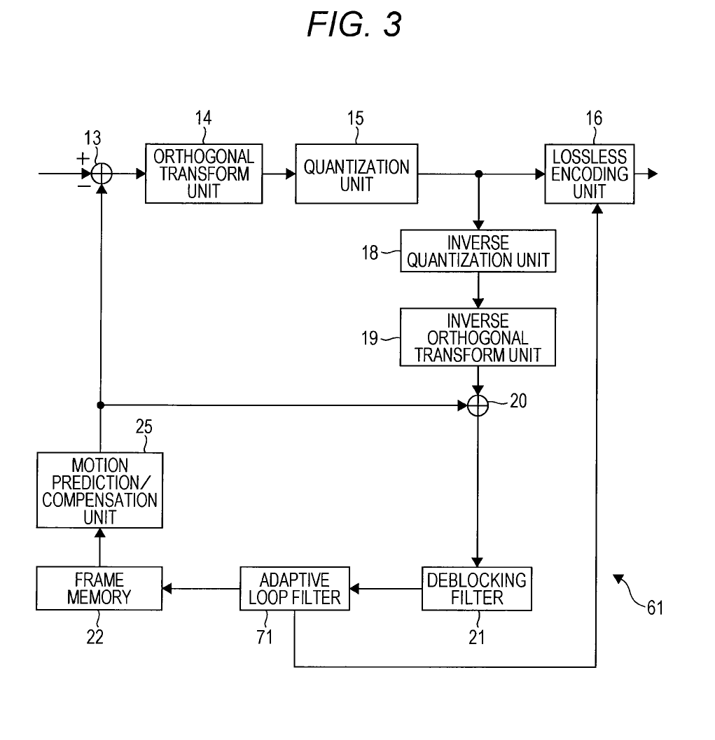

FIG. 3 is a block diagram showing an example structure of an image encoding device using an adaptive loop filter. In the example shown in FIG. 3, the A/D converter 11, the screen rearrangement buffer 12, the accumulation buffer 17, the selection unit 23, the intra prediction unit 24, the predicted image selection unit 26, and the rate control unit 27 shown in FIG. 1 are not shown, for ease of explanation. Arrows and the like are also omitted where appropriate. Therefore, in the example shown in FIG. 3, the reference image from the frame memory 22 is input directly to the motion prediction/compensation unit 25, and the predicted image from the motion prediction/compensation unit 25 is output directly to the arithmetic operation units 13 and 20.

That is, the image encoding device 61 shown in FIG. 3 differs from the image encoding device 1 shown in FIG. 1 only in that an adaptive loop filter 71 is added between the deblocking filter 21 and the frame memory 22.

The adaptive loop filter 71 calculates an adaptive loop filter coefficient so as to minimize the residual error in relation to the original image from the screen rearrangement buffer 12 (not shown), and performs a filtering process on the decoded image from the deblocking filter 21 by using the adaptive loop filter coefficient. This filter may be a Wiener filter, for example.

The adaptive loop filter 71 also sends the calculated adaptive loop filter coefficient to the lossless encoding unit 16. The lossless encoding unit 16 performs a lossless encoding process, such as variable-length encoding or arithmetic encoding, on the adaptive loop filter coefficient, and inserts the adaptive loop filter coefficient into the header portion of the compressed image.

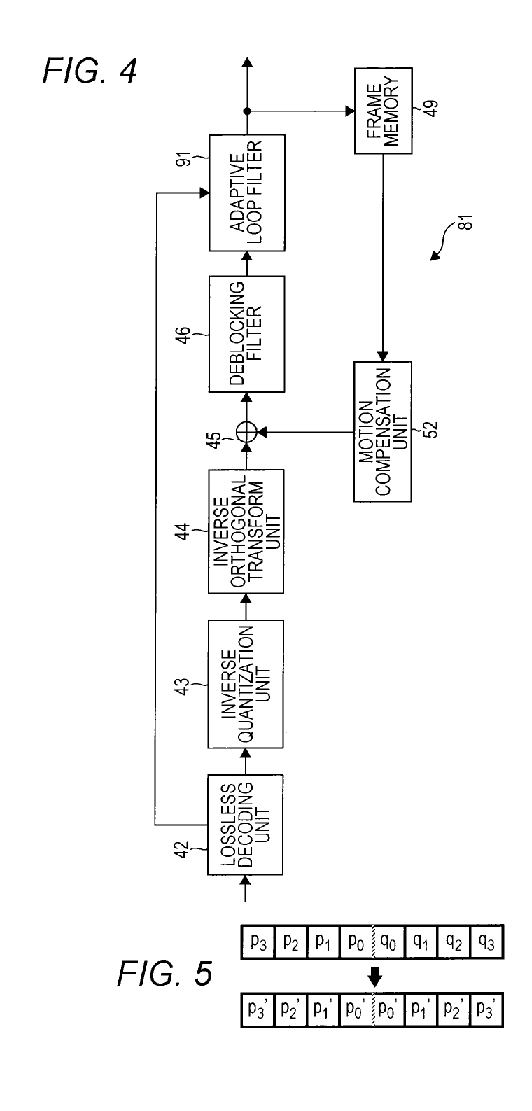

FIG. 4 is a block diagram showing an example structure of an image decoding device compatible with the image encoding device shown in FIG. 3. In the example shown in FIG. 4, the accumulation buffer 41, the screen rearrangement buffer 47, the D/A converter 48, the selection unit 50, the intra prediction unit 51, and the image selection unit 53 shown in FIG. 2 are not shown, for ease of explanation. Arrows and the like are also omitted where appropriate. Therefore, in the example shown in FIG. 4, the reference image from the frame memory 49 is input directly to the motion compensation unit 52, and the predicted image from the motion compensation unit 52 is output directly to the arithmetic operation unit 45.

That is, the image decoding device 81 shown in FIG. 4 differs from the image decoding device 31 shown in FIG. 2 only in that an adaptive loop filter 91 is added between the deblocking filter 46 and the frame memory 49.

The adaptive loop filter coefficient that is decoded and extracted from the header is supplied from the lossless decoding unit 42 to the adaptive loop filter 91. Using the supplied filter coefficient, the adaptive loop filter 91 performs a filtering process on the decoded image from the deblocking filter 46. This filter may be a Wiener filter, for example.

In this manner, decoded image quality can be improved, and reference image quality can also be improved.

[Deblocking Filter]

Next, a deblocking filter compliant with H.264/AVC is described. The deblocking filter 21 eliminates block distortion that is contained in motion compensation loops and in decoded images, or distortion in processing-unit regions. As a result, transmission of block distortion to the image to be referred to in motion compensation processes is prevented.

An operation of a deblocking filter can be selected from the three options (a) through (c) shown below in accordance with the two parameters: deblocking_filter_control_present_flag contained in Picture Parameter Set RBSP (Raw Byte Sequence Payload), and disable_deblocking_filter_idc contained in the slice header (Slice Header).

(a) To be performed on a block boundary or a macroblock boundary

(b) To be performed only on a macroblock boundary

(c) Not to be performed

As for the quantization parameter QP, QPY is used when the following process is performed on luminance signals, and QPC is used when the following process is performed on chrominance signals. In motion vector encoding, intra predictions, and entropy encoding (CAVLC/CABAC), pixel values that belong to a different slice are processed as “not available”. However, in deblocking filtering processes, pixel values that belong to a different slice but belong to the same picture are processed as “available”.

In the following, pixel values yet to be subjected to a deblocking filtering process are represented by p0 through p3 and q0 through q3, and processed pixel values are represented by p0′ through p3′ and q0′ through q3′, as shown in FIG. 5.

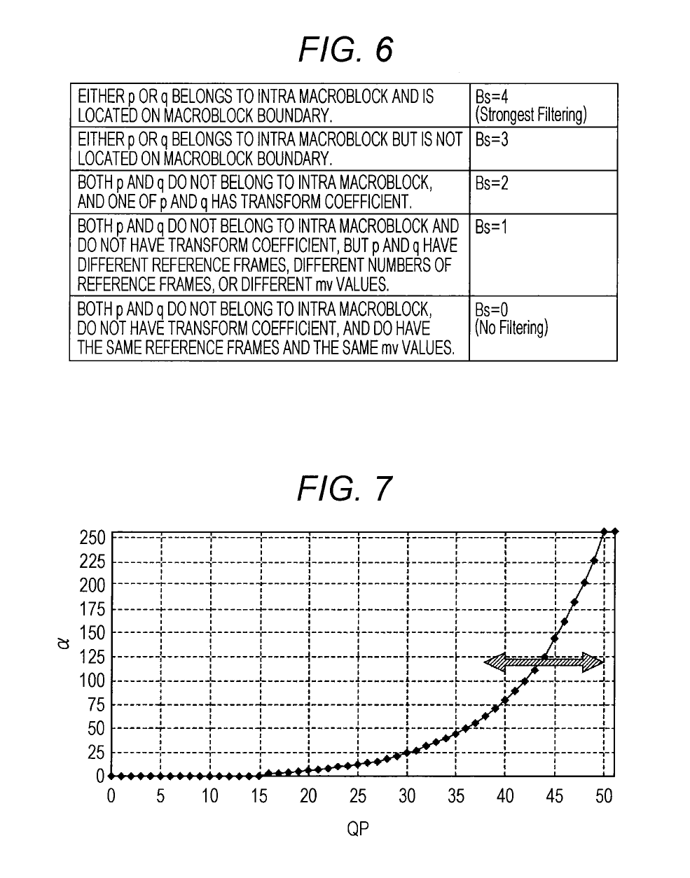

Prior to a deblocking filtering process, Bs (Boundary strength) that is block boundary strength data is defined for each of the pixels p and q shown in FIG. 5, as in the table shown in FIG. 6.

As shown in FIG. 6, when either a pixel p or a pixel q belongs to a macroblock to be subjected to intra encoding, and the pixel is located at a boundary between macroblocks, “4”, which indicates the highest filtering strength, is assigned to Bs.

When either a pixel p or a pixel q belongs to a macroblock to be subjected to intra encoding, and the pixel is not located at a boundary between macroblocks, “3”, which indicates the highest filtering strength after “4”, is assigned to Bs.

When both the pixels p and the pixels q do not belong to a macroblock to be subjected to intra encoding, and one of the pixels has a trans form coefficient, “2”, which indicates the highest filter intensity after “3”, is assigned to Bs.

Bs is “1” when both the pixels p and the pixels q do not belong to a macroblock to be subjected to intra encoding, any of the pixels does not have a transform coefficient, and the pixels have different reference frames, different numbers of reference frames, or different motion vectors.

Bs is “0” when both the pixels p and the pixels q do not belong to a macroblock to be subjected to intra encoding, and both pixels do not have a transform coefficient but have the same reference frames and the same motion vectors. It should be noted that “0” means that any filtering process is not to be performed.

Only when the conditions expressed by the expressions (1) and (2) shown below are satisfied, is a deblocking filtering process performed on (p2, p1, p0, q0, q1, and q2) in FIG. 5.

Bs>0 (1)

|p0−q0|<α; |p1−p0|<β; |q1−q0|<β (2)

In default configuration, the values of α and β in the expression (2) are determined in accordance with QP as described below. However, the user can adjust the strength by using the two parameters “slice_alpha_c0_offset_div2” and “slice_beta_offset_div2” contained in the slice header in encoded data, as indicated by the arrows in the graph.

FIG. 7 shows the relationship between QP and the threshold value α. When an offset is added to QP, the curve representing the relationship between QP and the threshold value a shifts in the directions shown by the arrows. Accordingly, it is apparent that the filtering strength can be adjusted.

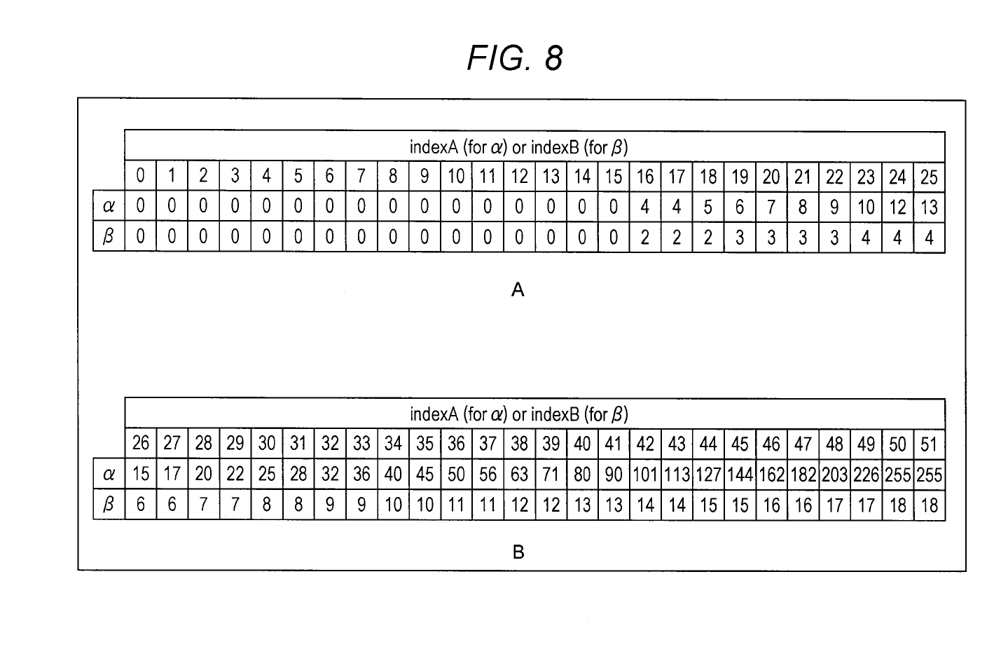

Also, the threshold value α is determined from the table shown in A in FIG. 8 by calculating “indexA” according to the expression (3) and the expression (4) shown below with the use of the respective quantization parameters qPₚ and qP_{q} of a block P and a block Q adjacent to each other. Likewise, the threshold value β is determined from the table shown in B in FIG. 8 by calculating “indexB” according to the expression (3) and the expression (5) with the use of the respective quantization parameters qPₚ and qP_{q} of the block P and the block Q adjacent to each other. The “indexA” and “indexB” are defined as shown in the following expressions (3) through (5).

qPₐᵥ=(qPₚ+qP_{q}+1)>>1 (3)

indexA=Clip3(0,51,qPₐᵥ+FilterOffsetA) (4)

indexB=Clip3(0,51,qPₐᵥ+FilterOffsetB) (5)

In the expressions (4) and (5), “FilterOffsetA” and “FilterOffsetB” are equivalent to the portions to be adjusted by the user.

Different methods are defined for deblocking filtering processes in cases where Bs<4, and where Bs=4, as described below.

First, where Bs<4, the pixel values p′ 0 and q′ 0 subjected to the deblocking filtering process are calculated according to the following expressions (6) through (8).

Δ=Clip3(−t_{c},t_{c}((((q0−p0)<<2)+(p1−q1)+4)>>3)) (6)

p′0=Clip1(p0+Δ) (7)

q′0=Clip1(q0+Δ) (8)

Here, t_{c} is calculated as shown in the expression (9) or (10) shown below. Specifically, where the value of “chromaEdgeFlag” is 0, t_{c} is calculated according to the expression (9) shown below.

t_{c}=t_{c0}+((aₚ<β)?1:0)+((a_{q}<β)?1:0) (9)

Where the value of “chromaEdgeFlag” is not 0, t_{c} is calculated according to the expression (10) shown below.

t_{c}=t_{c0}+1 (10)

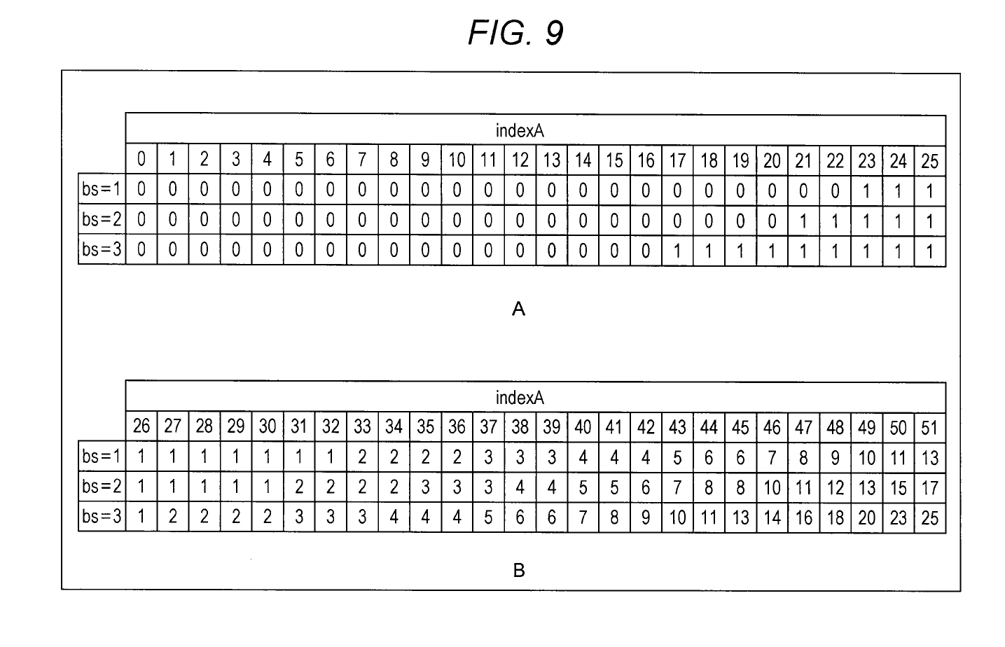

The value of t_{c0} is defined in accordance with the values of Bs and “indexA”, as shown in the tables in A in FIG. 9 and B in FIG. 9.

Also, the values of aₚ and a_{q} in the expression (9) are calculated according to the expressions (11) and (12) shown below.

aₚ=|p2−p0| (11)

a_{q}=|q2−q0| (12)

The pixel value p′1 subjected to the deblocking filtering process is determined as described below. Specifically, where the value of “chromaEdgeFlag” is “0”, and the value of aₚ is equal to or smaller than β, p′1 is calculated according to the expression (13) shown below.

p′1=p1+Clip3(−t_{c0},t_{c0},(p2+((p0+q0+1)>>1)−(p1<<1))>>1) (13)

When the expression (13) is not satisfied, p′1 is calculated according to the expression (14) shown below.

p′1=p1 (14)

The pixel value q′1 subjected to the deblocking filtering process is determined as described below. Specifically, where the value of “chromaEdgeFlag” is “0”, and the value of a_{q} is equal to or smaller than β, q′1 is calculated according to the expression (15) shown below.

q′1=q1+Clip3(−t_{c0},t_{c0},(q2+((p0+q0+1)>>1)−(q1<<1))>>1) (15)

When the expression (15) is not satisfied, q′1 is calculated according to the expression (16) shown below.

q′1=q1 (16)

The values of p′2 and q′2 are the same as the values of p2 and q2 prior to the filtering. Specifically, p′2 is determined according to the expression (17) shown below, and q′2 is determined according to the expression (18) shown below.

p′2=p2 (17)

q′2=q2 (18)

Next, where Bs=4, the pixel values p′i (i=0, . . . , 2) subjected to the deblocking filtering are calculated as described below. When the value of “chromaEdgeFlag” is “0”, and the condition shown in the expression (19) is satisfied, p′0, p′1, and p′2 are calculated according to the expressions (20) through (22) shown below.

ap<β&&|p0−q0|<((α>>2)+2) (19)

p′0=(p2+2×p1+2×p0+2×q0+q1+4)>>3 (20)

p′1=(p2+p1+p0+q0+2)>>2 (21)

p′2=(2×p3+3×p2+p1+p0+q0+4)>>3 (22)

When the expression (19) is not satisfied, p′0, p′1, and p′2 are calculated according to the expressions (23) through (25) shown below.

p′0=(2×p1+p0+q1+2)>>2 (23)

p′1=p1 (24)

p′2=p2 (25)

The pixel values q′i (I=0, . . . , 2) subjected to the deblocking filtering process are calculated as described below. Specifically, when the value of “chromaEdgeFlag” is “0”, and the condition shown in the expression (26) is satisfied, q′0, q′1, and q′2 are calculated according to the expressions (27) through (29) shown below.

aq<β&&|p0−q0|<((α>>2)+2) (26)

q′0=(p1+2×p0+2×q0+2×q1+q2+4)>>3 (27)

q′1=(p0+q0+q1+q2+2)>>2 (28)

q′2=(2×q3+3×q2+q1+q0+p4+4)>>3 (29)

When the expression (26) is not satisfied, q′0, q′1, and q′2 are calculated according to the expressions (30) through (32) shown below.

q′0=(2×q1+q0+p1+2)>>2 (30)

q′1=q1 (31)

q′2=q2 (32)

[Cost Functions]

To achieve higher encoding efficiency, it is critical to select an appropriate prediction mode by the AVC encoding method.

An example of such a selection method is a method implemented in H.264/MPEG-4 AVC reference software, called JM (Joint Model) (available at http://iphome.hhi.de/suchring/tml/index.htm).

In JM, the two mode determinationmethods described below, High Complexity Mode and Low Complexity Mode, can be selected. By either of the methods, a cost function value as to each prediction mode is calculated, and the prediction mode that minimizes the cost function value is selected as the optimum mode for the current block or macroblock.

A cost function in High Complexity Mode can be calculated according to the following expression (33).

Cost(ModeεΩ)=D+λ*R (33)

Here, Ω represents the universal set of candidate modes for encoding the current block or macroblock, and D represents the difference energy between a decoded image and an input image when encoded is performed in the current prediction mode. λ represents the Lagrange's undetermined multiplier provided as a quantization parameter function. R represents the total bit rate in a case where encoding is performed in the current mode, including the orthogonal transform coefficient.

That is, to perform encoding in High Complexity Mode, a provisional encoding process needs to be performed in all the candidate modes to calculate the above parameters D and R, and therefore, a larger amount of calculation is required.

A cost function in Low Complexity Mode can be calculated according to the following expression (34).

Cost(ModeεΩ)=D+QP2Quant(QP)*HeaderBit (34)

Here, D differs from that in High Complexity Mode, and represents the difference energy between a predicted image and an input image. QP2Quant(QP) represents a function of a quantization parameter QP, and HeaderBit represents the bit rate related to information that excludes the orthogonal transform coefficient and belongs to Header, such as motion vectors and the mode.

That is, in Low Complexity Mode, a prediction process needs to be performed for each of the candidate modes, but a decoded image is not required. Therefore, there is no need to perform an encoding process. Accordingly, the amount of calculation is smaller than that in High Complexity Mode.

[Coding Unit]

Next, Coding Units that are specified by the HEVC (High Efficiency Video Coding) encoding method (hereinafter referred to simply as HEVC) disclosed in Non-Patent Document 2 are described.

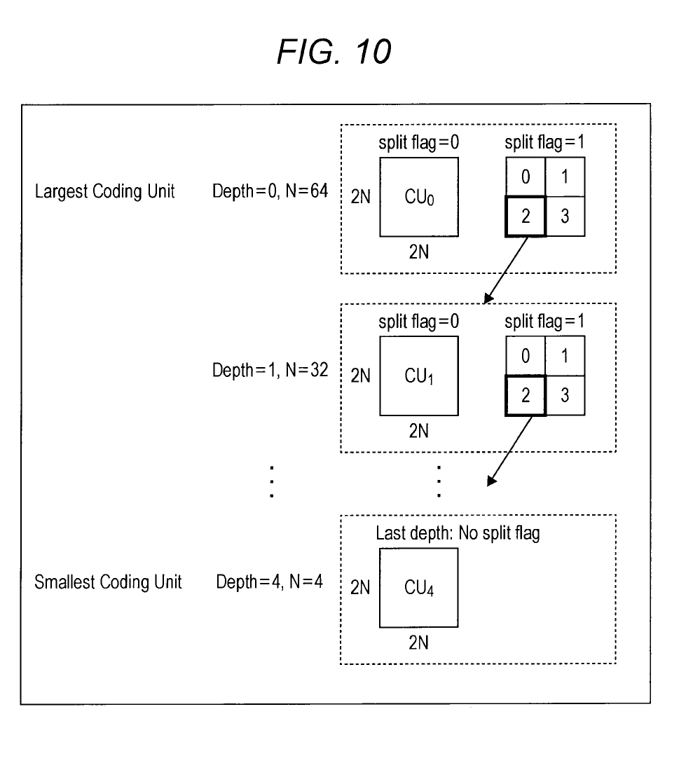

According to H.264/AVC, one macroblock is divided into motion compensation blocks, and the respective motion compensation blocks can be made to have different motion information. Specifically, H.264/AVC specifies a hierarchical structure formed with macroblocks and sub-macroblocks, but HEVC specifies Coding Units (CUs) as shown in FIG. 10.

CUs are also called Coding Tree Blocks (CTBs), and are partial regions of picture-based images that have the same roles as those of macroblocks compliant with H.264/AVC. While the size of the latter is limited to 16×16 pixels, the size of the former is not limited to a certain size, and may be designated by the compressed image information in each sequence.

For example, in a sequence parameter set (SPS) contained in encoded data to be output, the largest coding unit (LCU) and the smallest coding unit (SCU) of the CUs are specified.

In each LCU, split-flag=1 is set within a range not smaller than the SCU size, so that each LCU can be divided into CUs of a smaller size. In the example shown in FIG. 10, the size of the LCU is 128, and the greatest hierarchical depth is 5. When the value of split flag is “1”, a CU of 2N×2N in size is divided into CUs of N×N in size, which is one hierarchical level lower.

Further, the CUs are divided into Prediction Units (PUs) that are regions to be subjected to an intra or inter prediction process (partial regions of a picture-based image), and are divided into Transform Units (TUs) that are regions to be subjected to an orthogonal transform process (partial regions of a picture-based image). At present, 16×16 and 32×32 orthogonal transforms, as well as 4×4 and 8×8 orthogonal transforms, can be used according to HEVC.

In a case where CUs are defined, and each processing process is performed on the CU basis as in an operation according to HEVC, the macroblocks compliant with H.264/AVC can be considered equivalent to the LCUs. However, a CU has a hierarchical structure as shown in FIG. 10. Therefore, the size of the LCU on the highest hierarchical level is normally as large as 128×128 pixels, which is larger than the size of each macroblock compliant with H.264/AVC, for example.

This disclosure can be applied not only to encoding methods using macroblocks compliant with H.264/AVC, but also to encoding methods using CUs, PUs, TUs, and the like as in operations according to HEVC. That is, both “block” and “unit” mean a region being processed, and therefore, “current region”, which is either a block or a unit, will be used in the following description.

In the descriptions of examples involving H.264/AVC in the following, blocks are used in the descriptions, and the blocks are regions being processed and are equivalent to units according to HEVC. In the descriptions of examples involving HEVC, on the other hand, units are used in the descriptions, and the units are regions being processed and are equivalent to blocks according to H.264/AVC.

[Adaptive Offset Process According to HEVC]

Next, an adaptive offset filter compliant with HEVC is described. According to HEVC, the Sample Adaptive Offset method disclosed in Non-Patent Document 3 is adopted.

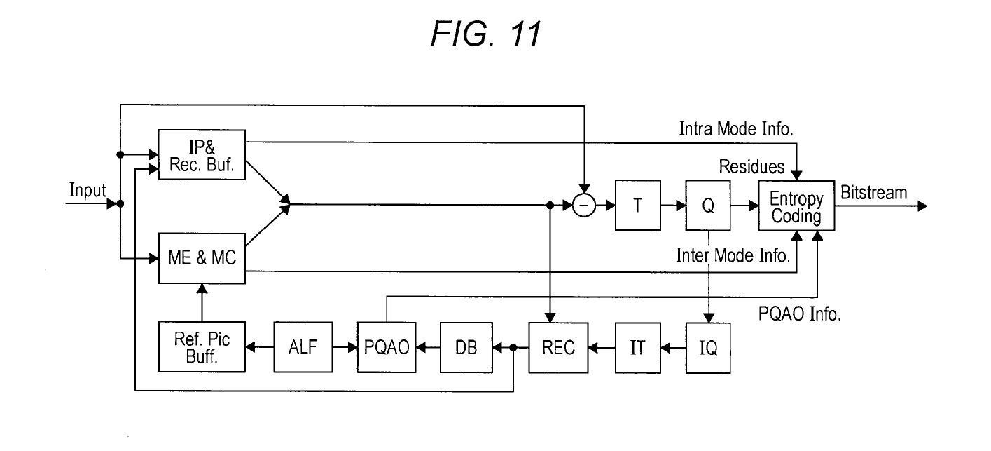

An adaptive offset filter (Picture Quality Adaptive Offset: PQAO) is provided between a deblocking filter (DB) and an adaptive loop filter (ALF), as shown in FIG. 11.

As for adaptive offset types, there are two “band offset” types and six “edge offset” types. It is also possible to use no offsets. An image may be divided according to “quad-tree”, and one of the above described adaptive offset types can be selected for encoding in each of the regions.

This selection information is encoded as PQAO Info. by an encoding unit (Entropy Coding) to generate a bit stream, and the generated bit stream is transmitted to the decoding side. By using this method, encoding efficiency can be increased.

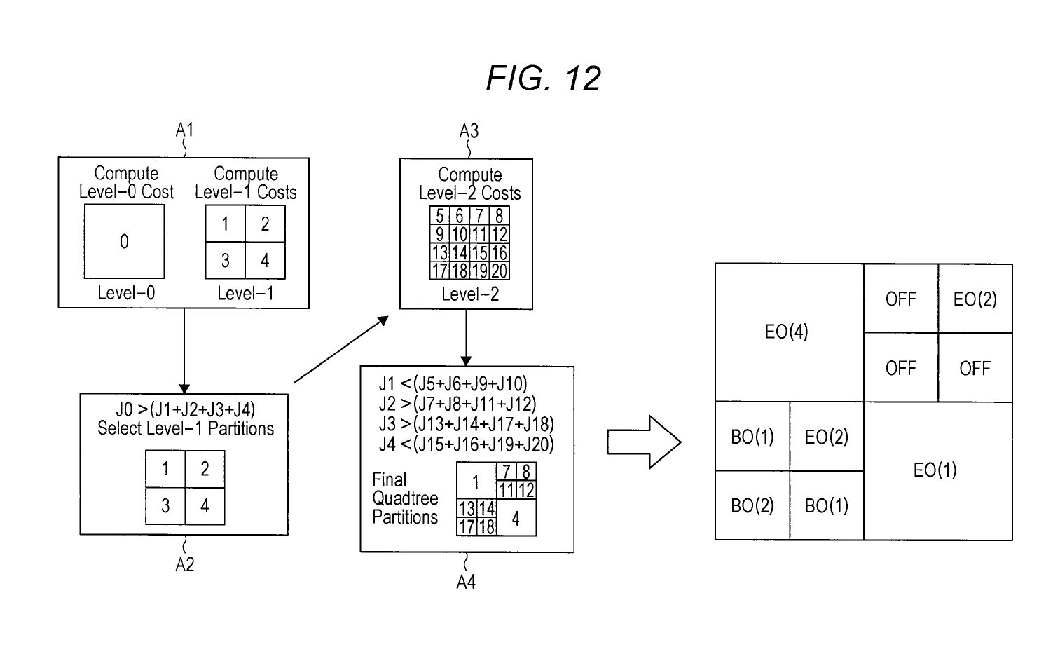

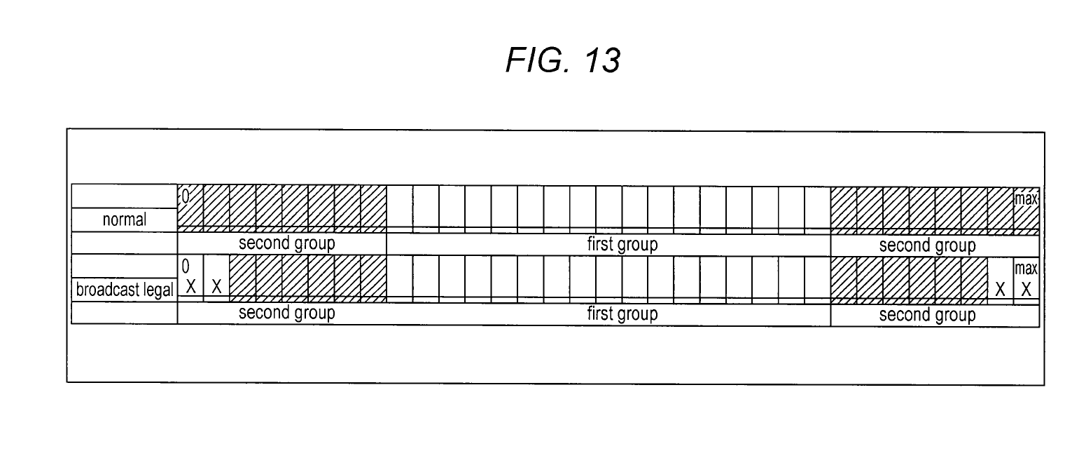

Referring now to FIG. 12, a quad-tree structure is described.

On the encoding side, for example, a cost function value J0 of Level-0 (division depth 0) indicating a state where a region 0 is not divided is calculated as shown in A1 in FIG. 12. Cost function values J1, J2, J3, and J4 of Level-1 (division depth 0) indicating a state where the region 0 is divided into four regions 1 through 4 are also calculated.

As shown in A2, the cost function values are compared, and the divisional regions (Partitions) of Level-1 are selected, as J0>(J1+J2+J3+J4).

Likewise, cost function values J5 through J20 of Level-2 (division depth 2) indicating a state where the region 0 is divided into 16 regions 5 through 20 is calculated as shown in A3.

As shown in A4, the cost function values are compared with one another, and the divisional regions (Partitions) of Level-1 are selected in the region 1, as J1<(J5+J6+J9+J10). In the region 2, the divisional regions (Partitions) of Level-2 are selected, as J2>(J7+J8+J11+J12). In the region 3, the divisional regions (Partitions) of Level-2 are selected, as J3>(J13+J14+J17+J18). In the region 4, the divisional regions (Partitions) of Level-1 are selected, as J4<(J15+J16+J19+J20).

As a result, the eventual quad-tree regions (Partitions) as shown in A4 in the quad-tree structure are determined. In each of the regions determined in the quad-tree structure, cost function values are calculated for the two band offset types, the six edge offset types, and “no offset”, and which offset is to be used for encoding is determined.

In the example shown in FIG. 12, EO(4), which is the fourth type among the edge offset types, is determined in the region 1, for example, as indicated by the white arrow. OFF or “no offset” is determined in the region 7, and EO(2), which is the second type among the edge offset types, is determined in the region 8. OFF or “no offset” is determined in the regions 11 and 12.

B0(1), which is the first type among the band offset types, is determined in the region 13, and EO(2), which is the second type among the edge offset types, is determined in the region 14. BO(2), which is the second type among the band offset types, is determined in the region 17, and BO(1), which is the first type among the band offset types, is determined in the region 18. EOM, which is the first type among the edge offset types, is determined in the region 4.

Referring now to FIG. 13, band offsets are described in detail.

In the example band offsets shown in FIG. 13, one division indicates one band=eight pixels, a luminance pixel value is divided into 32 bands, and the bands have offset values independently of one another.

That is, in the example shown in FIG. 13, the 16 bands in the middle among the pixels 0 through 255 (32 bands) form a first group, and the eight bands at either side form a second group.

Only the offset of either the first group or the second group is encoded, and is sent to the decoding side. In many cases, there is a strong color contrast or there are subtle shades in one region. It is rare that all the pixels exist in both the first group and the second group. Therefore, only one of the two offsets is sent, so that an increase in bit rate due to transmission of pixel values that are not included is prevented in each of the quad-tree regions.

When an input signal is broadcast, the luminance signal is restricted to the range of 16,235, and the chrominance signal is restricted to the range of 16,240. At this point, “broadcast legal” shown in the lower line in FIG. 13 is applied, and the offset values corresponding to the two bands at either end marked with x are not transmitted.

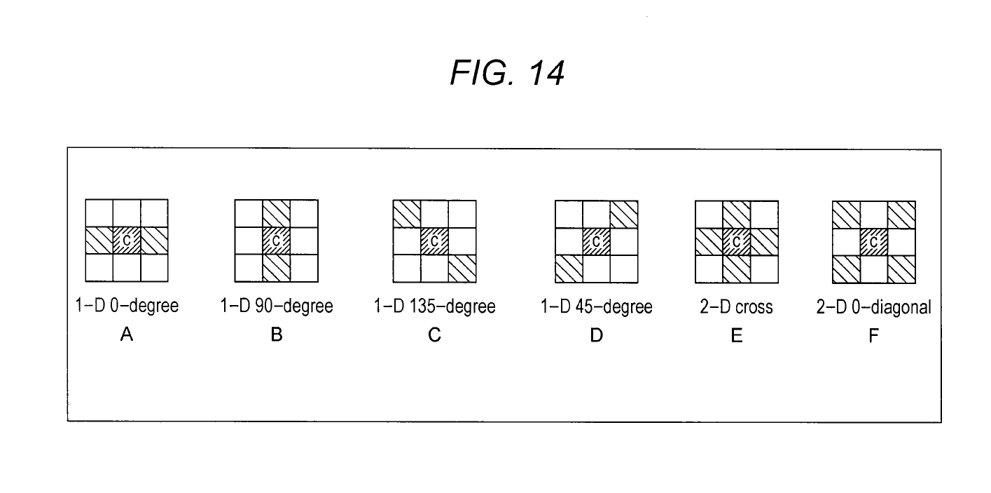

Referring now to FIG. 14, edge offsets are described in detail.

In an edge offset, the value of the current pixel is compared with the values of neighboring pixels adjacent to the current pixel, and an offset value is transmitted under the corresponding category.

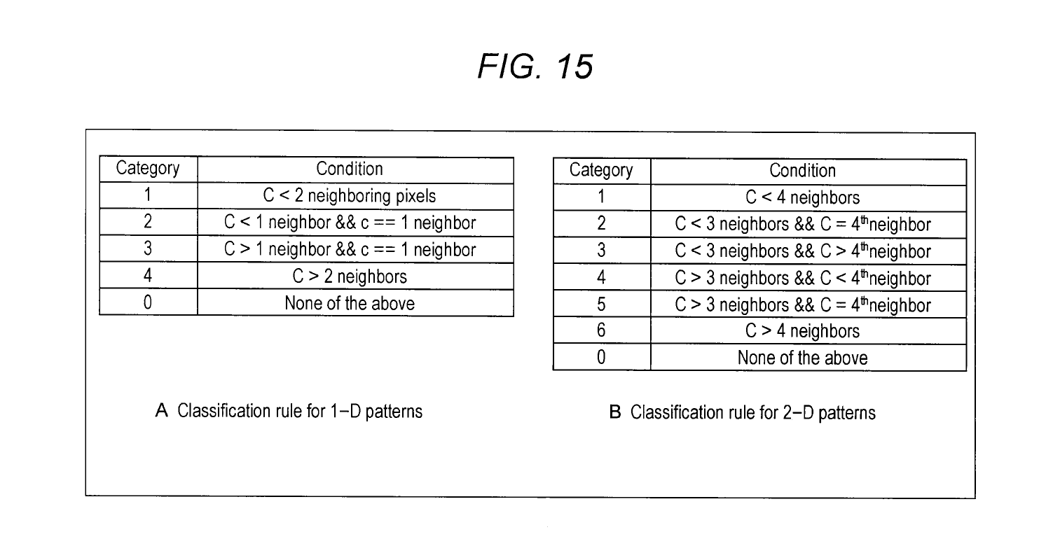

Edge offsets include four one-dimensional patterns shown in A through D in FIG. 14, and two two-dimensional patterns shown in E and F in FIG. 14. The respective offsets are transmitted under the categories shown in FIG. 15.

A in FIG. 14 shows a pattern in which neighboring pixels are one-dimensionally located on the right and left sides of the current pixel C, or a 1-D, 0-degree pattern at 0 degree to the pattern shown in A in FIG. 14. B in FIG. 14 shows a pattern in which neighboring pixels are one-dimensionally located on the upper side and the lower side of the current pixel C, or a 1-D, 90-degree pattern at 90 degrees to the pattern shown in A in FIG. 14.

C in FIG. 14 shows a pattern in which neighboring pixels are one-dimensionally located on the upper left side and the lower right side of the current pixel C, or a 1-D, 135-degree pattern at 135 degrees to the pattern shown in A in FIG. 14. D in FIG. 14 shows a pattern in which neighboring pixels are one-dimensionally located on the upper right side and the lower left side of the current pixel C, or a 1-D, 135-degree pattern at 45 degrees to the pattern shown in A in FIG. 14.

E in FIG. 14 shows a pattern in which neighboring pixels are two-dimensionally located on the upper and lower sides and the right and left sides of the current pixel C, or a 2-D, cross pattern that crosses at the current pixel C. Fin FIG. 14 shows a pattern in which neighboring pixels are two-dimensionally located on the upper right and lower left sides and the lower right and upper left sides of the current pixel C, or a 2-D, diagonal pattern that diagonally crosses at the current pixel C.

A in FIG. 15 shows a list of rules for one-dimensional patterns (Classification rule for 1-D patterns). The patterns shown in A through D in FIG. 14 are classified into the five categories shown in A in FIG. 15, and offsets are calculated according to the categories and are then sent to the decoding unit.

In a case where the pixel value of the current pixel C is smaller than the pixel values of the two neighboring pixels, the pattern is classified as Category 1. In a case where the pixel value of the current pixel C is smaller than the pixel value of one of the neighboring pixels and is the same as the pixel value of the other one of the neighboring pixels, the pattern is classified as Category 2. Ina case where the pixel value of the current pixel C is greater than the pixel value of one of the neighboring pixels and is the same as the pixel value of the other one of the neighboring pixels, the pattern is classified as Category 3. In a case where the pixel value of the current pixel C is greater than the pixel values of the two neighboring pixels, the pattern is classified as Category 4. A pattern that is not classified as any of the above is classified as Category 0.

B in FIG. 15 shows a list of rules for two-dimensional patterns (Classification rule for 2-D patterns). The patterns shown in E and F in FIG. 14 are classified into the seven categories shown in B in FIG. 15, and offsets are sent under the categories to the decoding unit.

In a case where the pixel value of the current pixel C is smaller than the pixel values of the four neighboring pixels, the pattern is classified as Category 1. In a case where the pixel value of the current pixel C is smaller than the pixel values of three of the neighboring pixels and is the same as the pixel value of the fourth one of the neighboring pixels, the pattern is classified as Category 2. In a case where the pixel value of the current pixel C is smaller than the pixel values of three of the neighboring pixels and is greater than the pixel value of the fourth one of the neighboring pixels, the pattern is classified as Category 3.

In a case where the pixel value of the current pixel C is greater than the pixel values of three of the neighboring pixels and is smaller than the pixel value of the fourth one of the neighboring pixels, the pattern is classified as Category 4. In a case where the pixel value of the current pixel C is greater than the pixel values of three of the neighboring pixels and is the same as the pixel value of the fourth one of the neighboring pixels, the pattern is classified as Category 5. In a case where the pixel value of the current pixel Cis greater than the pixel values of the four neighboring pixels, the pattern is classified as Category 6. A pattern that is not classified as any of the above is classified as Category 0.

As described above, only two neighboring pixels need to be compared with the current pixel in a one-dimensional pattern for an edge offset, and accordingly, the amount of calculation is smaller. Under the “high efficiency” encoding conditions, 1-bit offset values are made more precise than those under “low delay” encoding conditions, and are then sent to the decoding side.

The above described adaptive offset process is performed for each of the regions determined in a quad-tree structure or for each block compliant with HEVC. Therefore, there is a possibility that block distortion will appear, since the above described block-based process is performed after deblocking filtering.

In the light of the above, an adaptive offset process is performed prior to deblocking filtering in this embodiment. Also, in the deblocking filtering after the adaptive offset process, the filtering strength is adjusted, with the adaptive offset process being taken into account. As a result, block distortion is removed more appropriately, and decoded image quality is improved.

[Example Structure of an Image Encoding Device]

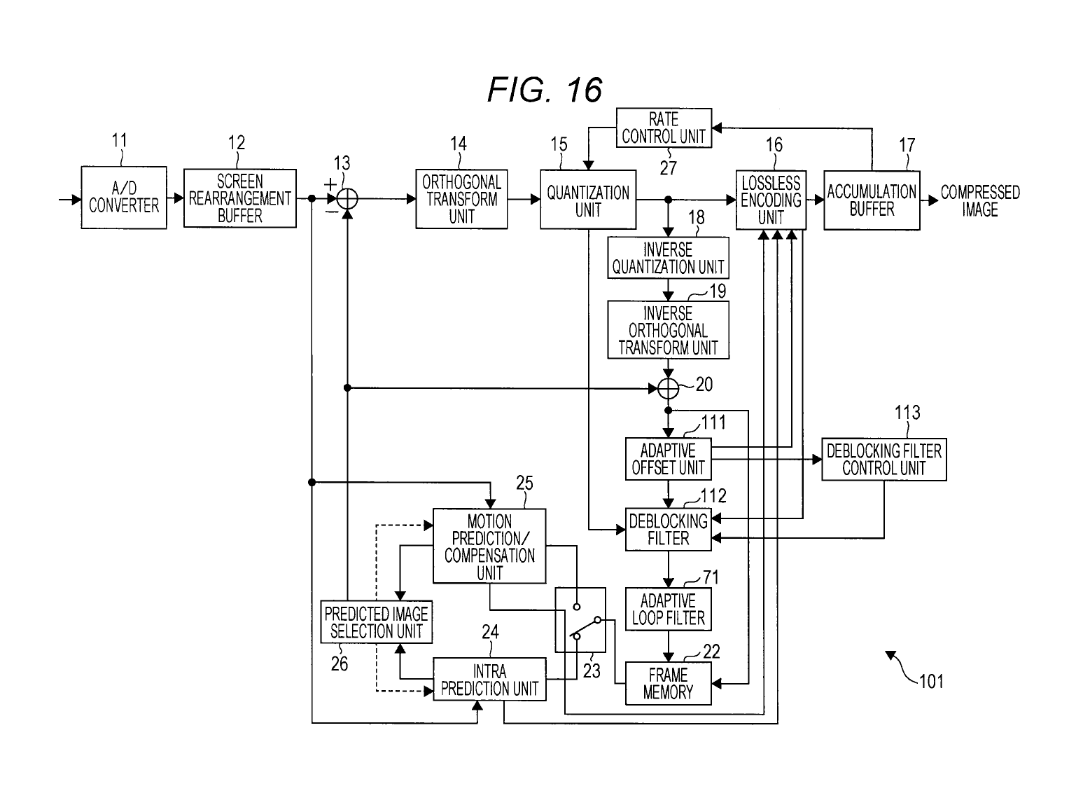

FIG. 16 shows the structure of an embodiment of an image encoding device as an image processing device to which the present disclosure is applied.

The image encoding device 101 shown in FIG. 16 encodes image data by using prediction processes. The encoding method used here may be a method compliant with HEVC (High Efficiency Video Coding), for example. However, the encoding method differs from the HEVC method described above with reference to FIG. 11 in that an adaptive offset unit 111 is placed before a deblocking filter 112 in the image encoding device 101.

Like the image encoding device 1 shown in FIG. 1, the image encoding device 101 shown in FIG. 16 includes an A/D converter 11, a screen rearrangement buffer 12, an arithmetic operation unit 13, an orthogonal transform unit 14, a quantization unit 15, a lossless encoding unit 16, an accumulation buffer 17, an inverse quantization unit 18, and an inverse orthogonal transform unit 19. Like the image encoding device 1 shown in FIG. 1, the image encoding device 101 shown in FIG. 16 includes an arithmetic operation unit 20, a frame memory 22, a selection unit 23, an intra prediction unit 24, a motion prediction/compensation unit 25, a predicted image selection unit 26, and a rate control unit 27.

The image encoding device 101 shown in FIG. 16 differs from the image encoding device 1 shown in FIG. 1 in that the above described adaptive loop filter 71 shown in FIG. 3 is added.

Furthermore, the image encoding device 101 shown in FIG. 16 differs from the image encoding device 1 shown in FIG. 1 in that the deblocking filter 21 is replaced with the deblocking filter 112, and the adaptive offset unit 111 and a deblocking filter control unit 113 are added.

Like the quantization unit 15 shown in FIG. 1, the quantization unit 15 sets a quantization parameter and performs quantization based on target bit rate information supplied from the rate control unit 27. In doing so, however, the quantization unit 15 supplies the information about the set quantization parameter to the deblocking filter 112.

Like the lossless encoding unit 16 shown in FIG. 1, the lossless encoding unit 16 not only encodes the quantized transform coefficient, but also incorporates various kinds of information such as a filter coefficient, prediction mode information, and the quantization parameter, into the header information in encoded data. In doing so, however, the lossless encoding unit 16 also incorporates the information about the quad-tree structure and the offset values from the adaptive offset unit 111 into the header information in the encoded data. The lossless encoding unit 16 also supplies syntax elements such as the prediction mode information and motion vector information to the deblocking filter 112.

The adaptive offset unit 111, the deblocking filter 112 (including the deblocking filter control unit 113), and the adaptive loop filter 71 are placed in this order in the motion compensation loop. The motion compensation loop is the block formed with the arithmetic operation unit 13, the orthogonal transform unit 14, the quantization unit 15, the inverse quantization unit 18, the inverse orthogonal transform unit 19, the arithmetic operation unit 20, the frame memory 22, the selection unit 23, the intra prediction unit 24 or the motion prediction/compensation unit 25, and the predicted image selection unit 26. Hereinafter, filtering processes to be performed by the adaptive offset unit 111, the deblocking filter 112, and the adaptive loop filter 71 in the motion compensation loop will be collectively referred to as the in-loop filtering process.

The adaptive offset unit 111 performs an offset process on a decoded image (locally-decoded baseband information) from the arithmetic operation unit 20. That is, the adaptive offset unit 111 determines the quad-tree structure described above with reference to FIG. 12. Specifically, the adaptive offset unit 111 divides the decoded image into regions according to the “quad-tree”, and, for each of the divisional regions, determines an offset type among the two band offset types, the six edge offset types, and “no offset”. The adaptive offset unit 111 also calculates an offset value for each of the divisional regions by referring to the quad-tree structure.

Using the determined quad-tree structure and the offset values, the adaptive offset unit 111 further performs an offset process on the decoded image from the arithmetic operation unit 20. The adaptive offset unit 111 then supplies the image subjected to the offset process, to the deblocking filter 112. The adaptive offset unit 111 also supplies information about the determined quad-tree structure to the deblocking filter control unit 113, and supplies information about the determined quad-tree structure and the calculated offsets to the lossless encoding unit 16.

The deblocking filter 112 receives information about the quantization parameter of the current region from the quantization unit 15, the syntax elements from the lossless encoding unit 16, and control information from the deblocking filter control unit 113. The deblocking filter 112 determines a filter parameter based on the quantization parameter and the syntax elements. The deblocking filter 112 also adjusts the filtering strength of the determined filter parameter based on the control information from the deblocking filter control unit 113. The deblocking filter 112 determines a filter (filter characteristics) by using the determined or adjusted filter parameter, and performs a deblocking filtering process on the image subjected to the offset process by using the determined filter. The filtered image is supplied to the adaptive loop filter 71.

Based on the information about the quad-tree structure from the adaptive offset unit 111, the deblocking filter control unit 113 determines whether the current region in the deblocking filtering process is at a boundary of the current region in the adaptive offset process. If the current region in the deblocking filtering process is at a boundary of the current region in the adaptive offset process, the deblocking filter control unit 113 supplies control information for increasing the filtering strength to the deblocking filter 112.

The adaptive loop filter 71 calculates an adaptive loop filter coefficient, and performs a filtering process on the decoded image from the deblocking filter 112 by using the adaptive loop filter coefficient, so as to minimize the residual error in relation to the original image (not shown) from the screen rearrangement buffer 12. This filter may be a Wiener filter, for example. In this manner, image quality is improved.

Although not illustrated in the drawing, the adaptive loop filter 71 also sends the calculated adaptive loop filter coefficient to the lossless encoding unit 16. The lossless encoding unit 16 performs a lossless encoding process, such as variable-length encoding or arithmetic encoding, on the adaptive loop filter coefficient, and inserts the adaptive loop filter coefficient into the header portion of the compressed image.

[In-Loop Filtering Process According to the Present Disclosure]

The in-loop filtering process to be performed by the adaptive offset unit 111, the deblocking filter 112, the deblocking filter control unit 113, and the adaptive loop filter 71 shown in FIG. 16 is now described. The operating principles of the adaptive loop filter 71 are the same as those described above with reference to FIG. 3.

In the in-loop filtering process by the image encoding device 101, a filtering process is first performed by the adaptive offset unit 111 prior to the deblocking filter 112. As a result, block distortion caused by the filtering process performed by the adaptive offset unit 111 can be removed by the deblocking filter.

Further, in the deblocking filter 112, a deblocking filtering process taking the adaptive offset process into account is performed by the deblocking filter control unit 113.

Referring again to FIG. 12, the adaptive offset process is described. In the quad-tree structure shown in FIG. 12, there are regions where edge offsets are determined as indicated by “EO”, regions where band offsets are determined as indicated by “BO”, and regions where no offsets are set as indicated by “OFF”. It is considered that, at the boundary between two regions having different offsets determined therein like the above mentioned regions in the quad-tree structure, block distortion is likely to occur.

Also, it is considered that, if the current region and a neighboring region adjacent to the current region are both edge offset regions but are classified into different categories, block distortion is likely to occur at the boundary. For example, the region that is represented by EO(4) in FIG. 12 and is determined to be Category 4, and the region that is represented by EO(1) and is determined to be Category 1 are edge offset regions, but are classified into different categories.

The same applies to band offset regions. That is, it is considered that, if the current region and a neighboring region adjacent to the current region are both band offset regions but are classified into different categories, block distortion is likely to occur at the boundary.

Therefore, when the current region in the deblocking filtering process is at the boundary between regions such as the above described regions, the deblocking filter control unit 113 causes the deblocking filter 112 to perform a filtering process of a higher strength on the boundary of the region by one of the methods described below.

According to a first method, the value of Bs (Boundary Strength) described above with reference to FIG. 6 is incremented by +1 for the boundary of the region.

According to a second method, the value of Bs is set to 4 for the boundary of the region, regardless of the other conditions.

Alternatively, strength adjustment may not be performed by adjusting the value of Bs as with the first and second methods, but strength adjustment may be controlled by adjusting the threshold value α/β described above with reference to FIGS. 7 and 8.

That is, according to a third method, the threshold value α and the threshold value β are determined for the boundary of the region by performing table reduction with QP+ΔQP using a predetermined ΔQP, instead of the quantization parameter QP, in FIGS. 7 and 8.

In this manner, the deblocking filter control unit 113 causes the deblocking filter 112 in the later stage to reflect the result of the adaptive offset process (the information about the quad-tree structure) in the filtering process. As a result, block distortion can be removed more appropriately, and decoded image quality can be improved.

[Example Structures of the Adaptive Offset Unit and the Deblocking Filter]

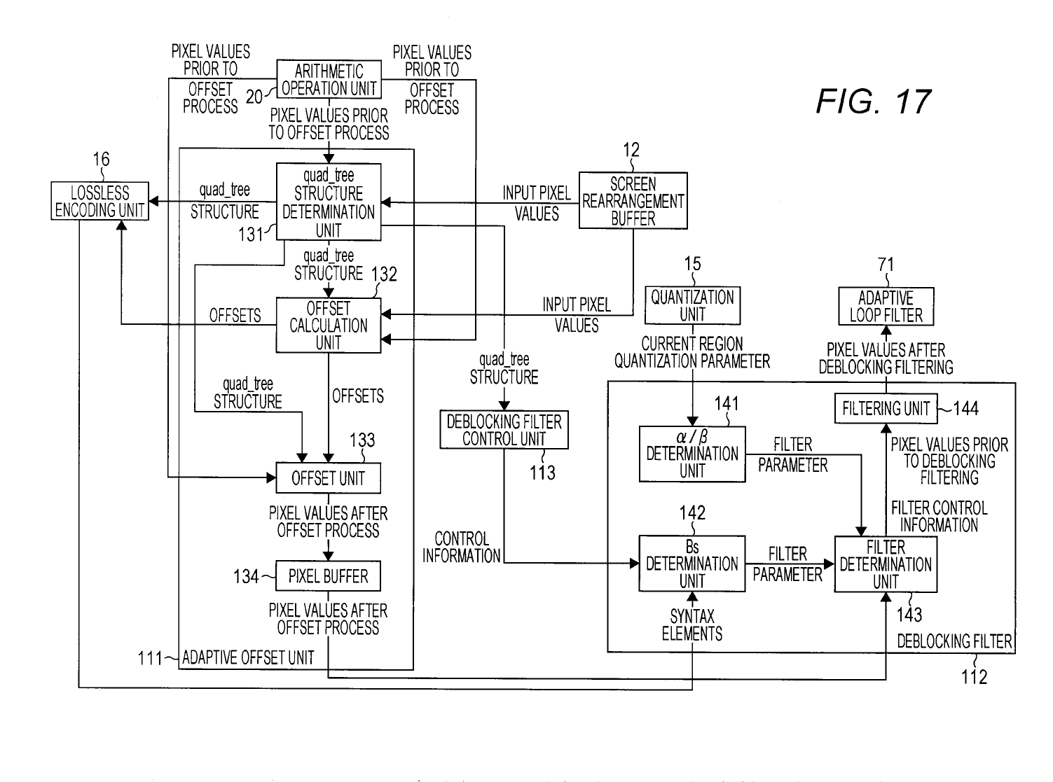

Next, the respective components of the image encoding device 101 are described. FIG. 17 is a block diagram showing example structures of the adaptive offset unit 111 and the deblocking filter 112. In the example shown in FIG. 17, filter strength adjustment is performed by adjusting the value of Bs by using the first or second method as the filtering strength adjustment method.

In the example shown in FIG. 17, the adaptive offset unit 111 is designed to include a quad-tree structure determination unit 131, an offset calculation unit 132, an offset unit 133, and a pixel buffer 134.

The deblocking filter 112 is designed to include an α/β determination unit 141, a Bs determination unit 142, a filter determination unit 143, and a filtering unit 144.

Pixel values yet to be subjected to an offset process are supplied from the arithmetic operation unit 20 to the quad-tree structure determination unit 131, the offset calculation unit 132, and the offset unit 133. Although not shown in FIG. 16 for ease of explanation, input pixel values are actually supplied from the screen rearrangement buffer 12 to the quad-tree structure determination unit 131 and the offset calculation unit 132.

Using the pixel values yet to be subjected to an offset process and the input pixel values from the screen rearrangement buffer 12, the quad-tree structure determination unit 131 determines a quad-tree structure as described above with reference to FIG. 12. That is, the quad-tree structure determination unit 131 divides the image according to the “quad-tree”, and calculates cost function values by using the pixel values yet to be subjected to an offset process and the input pixel values, to determine which one of the above described adaptive offset types is to be used for encoding in each of the divisional regions.

The quad-tree structure determination unit 131 supplies the information about the determined quad-tree structure to the offset calculation unit 132, the offset unit 133, the deblocking filter control unit 113, and the lossless encoding unit 16.

The offset calculation unit 132 calculates the offset for each region obtained by the quad-tree division indicated by the information from the quad-tree structure determination unit 131 with respect to the pixel values that are supplied from the arithmetic operation unit 20 and have not been subjected to an offset process. The offset calculation unit 132 supplies the information about the calculated offsets to the offset unit 133 and the lossless encoding unit 16.

The lossless encoding unit 16 receives the quad-tree structure information from the quad-tree structure determination unit 131 and the offset information from the offset calculation unit 132, and encodes those pieces of information to generate header information about the encoded data.

The offset unit 133 performs an offset process on the pixel values that are supplied from the arithmetic operation unit 20 and have not been subjected to an offset process. That is, the offset unit 133 adds the offset values indicated by the information supplied from the offset calculation unit 132, to the pixel values of the respective regions formed through the quad-tree division performed by the quad-tree structure determination unit 131. The offset unit 133 accumulates the pixel values subjected to the offset process in the pixel buffer 134.

The pixel buffer 134 accumulates the pixel values subjected to the offset process, and supplies the accumulated pixel values subjected to the offset process to the filter determination unit 143 at a predetermined time.

The α/β determination unit 141 acquires the information about the quantization parameter of the current region in the deblocking filtering process from the quantization unit 15, and, based on the quantization parameter indicated by the acquired information, determines the threshold value α/β described above with reference to FIGS. 7 and 8. The α/β determination unit 141 supplies the determined threshold value α/β as a filter parameter to the filter determination unit 143.

The Bs determination unit 142 acquires syntax elements such as a prediction mode and motion vector information from the lossless encoding unit 16. Based on the acquired information, the Bs determination unit 142 determines the value of Bs by the method described above with reference to FIG. 6. When receiving control information from the deblocking filter control unit 113, the Bs determination unit 142 adjusts the value of Bs by the above described first or second method in accordance with the control information from the deblocking filter control unit 113. The Bs determination unit 142 supplies the determined or adjusted value of Bs as a filter parameter to the filter determination unit 143.

The filter determination unit 143 determines a filter (filter characteristics) from the filter parameters supplied from the α/β determination unit 141 and the Bs determination unit 142, and supplies control information about the determined filter to the filtering unit 144. In doing so, the filter determination unit 143 also supplies the pixel values that are supplied from the pixel buffer 134, have been subjected to the offset process, and have not been subjected to deblocking filtering, to the filtering unit 144.

The filtering unit 144 performs a filtering process on the pixel values that are supplied from the filter determination unit 143 and have not been subjected to deblocking filtering, by using the filter indicated by the filter control information supplied from the filter determination unit 143. The filtering unit 144 supplies the filtered pixel values subjected to the deblocking filtering to the adaptive loop filter 71.

[Flow of an Encoding Process]

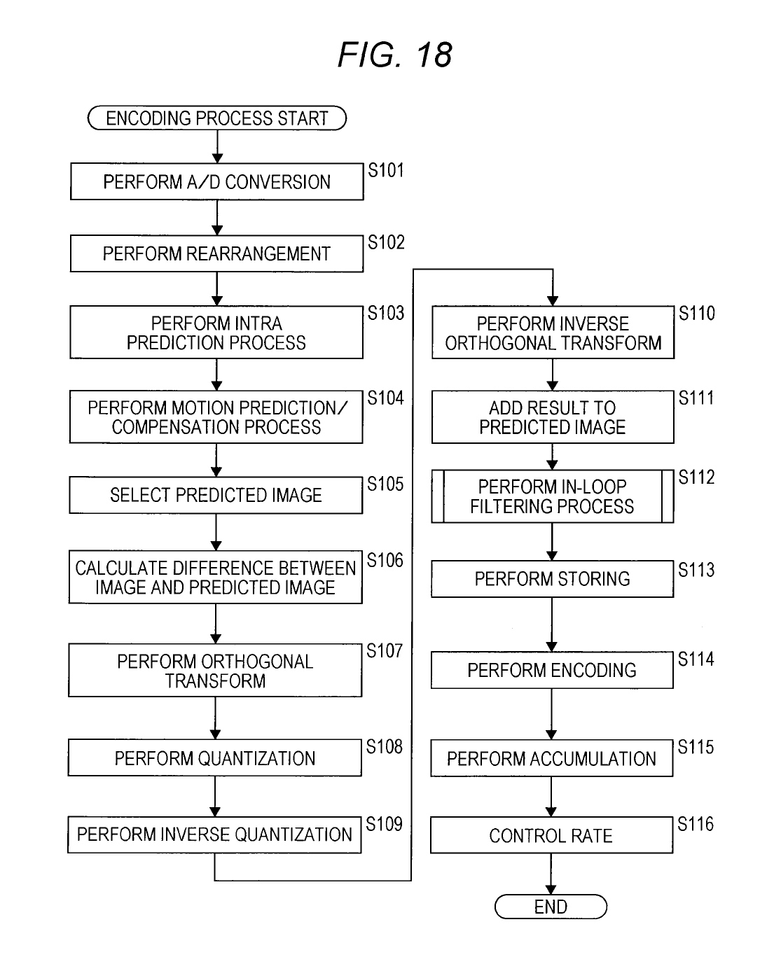

Next, the flow of each process to be performed by the above described image encoding device 101 is described. Referring first to the flowchart shown in FIG. 18, an example flow of an encoding process is described.

In step S101, the A/D converter 11 performs an A/D conversion on an input image. In step S102, the screen rearrangement buffer 12 stores the image subjected to the A/D conversion, and rearranges the respective pictures in encoding order, instead of displaying order.

When an image that is supplied from the screen rearrangement buffer 12 and is to be processed is an image of a block to be intra-processed, a decoded image to be referred to is read from the frame memory 22, and is supplied to the intra prediction unit 24 via the selection unit 23.

Based on those images, the intra prediction unit 24 in step S103 performs intra predictions on the pixels of the block being processed in all candidate intra prediction modes. The decoded pixels to be referred to are pixels that have not been filtered or offset by any of the adaptive offset unit 111, the deblocking filter 112, and the adaptive loop filter 71.

Through this process, intra predictions are performed in all the candidate intra prediction modes, and cost function values are calculated by using the cost function shown in the expression (33) or (34) in all the candidate intra prediction modes. Based on the calculated cost function values, an optimum intra prediction mode is selected, and a predicted image generated through an intra prediction in the optimum intra prediction mode and the cost function value thereof are supplied to the predicted image selection unit 26.

When an image that is supplied from the screen rearrangement buffer 12 and is to be processed is an image to be inter-processed, an image to be referred to is read from the frame memory 22, and is supplied to the motion prediction/compensation unit 25 via the selection unit 23. Based on those images, the motion prediction/compensation unit 25 in step S104 performs a motion prediction/compensation process.

Through this process, motion prediction processes are performed in all the candidate inter prediction modes, and cost function values are calculated by using the cost function shown in the expression (33) or (34) in all the candidate inter prediction modes. Based on the calculated cost function values, an optimum inter prediction mode is determined, and a predicted image generated in the optimum inter prediction mode and the cost function value thereof are supplied to the predicted image selection unit 26.

In step S105, based on the respective cost function values output from the intra prediction unit 24 and the motion prediction/compensation unit 25, the predicted image selection unit 26 determines an optimum prediction mode that is either the optimum intra prediction mode or the optimum inter prediction mode. The predicted image selection unit 26 selects the predicted image generated in the determined optimum prediction mode, and supplies the selected predicted image to the arithmetic operation units 13 and 20. This predicted image is to be used in the later described arithmetic operations in steps S106 and S111.

The selection information about this predicted image is supplied to the intra prediction unit 24 or the motion prediction/compensation unit 25. When the predicted image generated in the optimum intra prediction mode is selected, the intra prediction unit 24 supplies the information indicating the optimum intra prediction mode (or intra prediction mode information) to the lossless encoding unit 16.

When the predicted image generated in the optimum inter prediction mode is selected, the motion prediction/compensation unit 25 outputs the information indicating the optimum inter prediction mode, and, if necessary, further outputs the information corresponding to the optimum inter prediction mode to the lossless encoding unit 16. The information corresponding to the optimum inter prediction mode may be motion vector information, reference frame information, and the like.

In step S106, the arithmetic operation unit 13 calculates the difference between the image rearranged in step S102 and the predicted image selected in step S105 The predicted image is supplied to the arithmetic operation unit 13 via the predicted image selection unit 26 from the motion prediction/compensation unit 25 when an inter prediction is performed, and from the intra prediction unit 24 when an intra prediction is performed.

The difference data is smaller in data amount than the original image data. Accordingly, the data amount can be made smaller than in a case where images are directly encoded.

In step S107, the orthogonal transform unit 14 performs an orthogonal transform on the difference information supplied from the arithmetic operation unit 13. Specifically, an orthogonal transform such as a discrete cosine transform or a Karhunen-Loeve transform is performed, and a transform coefficient is output.

In step S108, the quantization unit 15 quantizes the transform coefficient. As will be explained later in the description of the processing in step S116, the quantization unit 15 sets a quantization parameter based on target bit rate information supplied from the rate control unit 27, and performs quantization. In doing so, the quantization unit 15 supplies the information about the set quantization parameter to the deblocking filter 112.

The difference information quantized in the above manner is locally decoded in the following manner. Specifically, in step S109, the inverse quantization unit 18 inversely quantizes the transform coefficient quantized by the quantization unit 15, having characteristics compatible with the characteristics of the quantization unit 15. In step S110, the inverse orthogonal transform unit 19 performs an inverse orthogonal transform on the transform coefficient inversely quantized by the inverse quantization unit 18, having the characteristics compatible with the characteristics of the orthogonal transform unit 14.

In step S111, the arithmetic operation unit 20 adds the predicted image input via the predicted image selection unit 26 to the locally decoded difference information, and generates a locally decoded image (an image corresponding to the input to the arithmetic operation unit 13).

In step S112, the adaptive offset unit 111, the deblocking filter 112, the deblocking filter control unit 113, and the adaptive loop filter 71 perform the in-loop filtering process. Through this in-loop filtering process, an adaptive offset process is performed, and ringing and the like are removed.

Also, through this in-loop filtering process, a filter is determined based not only on the quantization parameter from the quantization unit 15 and the syntax elements from the lossless encoding unit 16 but also on the result (quad-tree structure information) of the adaptive offset process. A deblocking filtering process using the determined filter is then performed on the pixel values subjected to the offset process, to remove block distortion. Through this in-loop filtering process, an adaptive loop filtering process is performed on the pixel values subjected to the deblocking filtering, to minimize degradation and improve image quality. The pixel values subjected to the adaptive filtering process are output to the frame memory 22.

As will be described later in detail, the information about the quad-tree structure and the offsets calculated through the adaptive offset process is supplied to the lossless encoding unit 16.

In step S113, the frame memory 22 stores the filtered image. The image that has not been filtered or offset by any of the adaptive offset unit 111, the deblocking filter 112, and the adaptive loop filter 71 is also supplied from the arithmetic operation unit 20, and is stored into the frame memory 22.

Meanwhile, the transform coefficient quantized in step S108 is also supplied to the lossless encoding unit 16. In step S114, the lossless encoding unit 16 encodes the quantized transform coefficient that has been output from the quantization unit 15. That is, the difference image is subjected to lossless encoding such as variable-length encoding or arithmetic encoding, and is compressed.

At this point, the intra prediction mode information from the intra prediction unit 24 or the information corresponding to the optimum inter prediction mode from the motion prediction/compensation unit 25, which has been input to the lossless encoding unit 16 in step S105, is also encoded and is then added to the header information. Further, the information about the quad-tree structure and the offsets, which has been input to the lossless encoding unit 16 in step S112, is also encoded and is then added to the header information.

For example, the information indicating an inter prediction mode is encoded for each LCU. The motion vector information and the reference frame information are encoded for each PU being processed.

At this point, the lossless encoding unit 16 also supplies syntax elements such as the prediction mode information and motion vector information to the deblocking filter 112.

In step S115, the accumulation buffer 17 stores the difference image as a compressed image. The compressed image stored in the accumulation buffer 17 is read out when necessary, and is transmitted to the decoding end via a transmission path.

In step S116, based on the compressed image stored in the accumulation buffer 17, the rate control unit 27 controls the quantization operation rate of the quantization unit 15 so as not to cause an overflow or underflow.

When the processing in step S116 is completed, the encoding process comes to an end.

[Flow of the In-Loop Filtering Process]

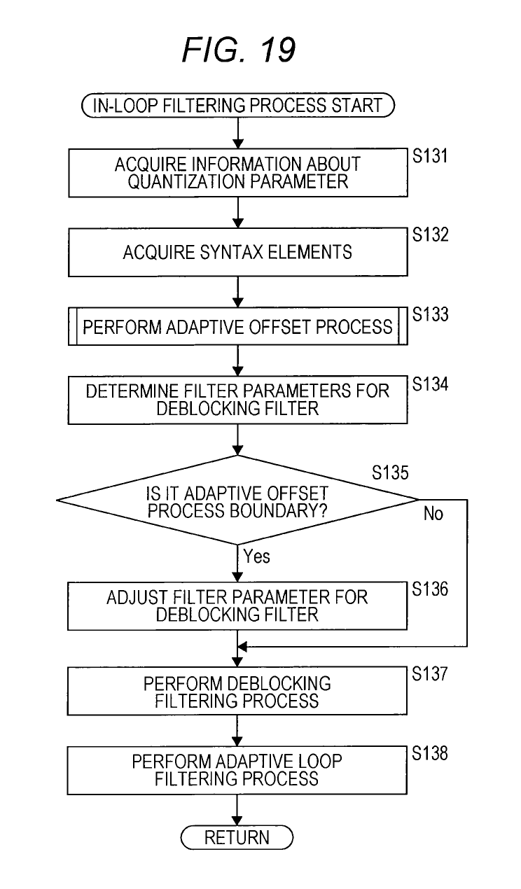

Referring now to the flowchart shown in FIG. 19, an example flow of the in-loop filtering process performed in step S112 in FIG. 18 is described. This in-loop filtering process is a process to be performed by the adaptive offset unit 111, the deblocking filter 112, the deblocking filter control unit 113, and the adaptive loop filter 71.

By the processing in step S108 in FIG. 19, the quantization unit 15 supplies the information about the quantization parameter to the deblocking filter 112. In turn, the α/β determination unit 141 in step S131 acquires the information about the quantization parameter supplied from the quantization unit 15.

By the processing in step S114 in FIG. 19, the lossless encoding unit 16 also supplies syntax elements such as the prediction mode information and the motion vector information to the deblocking filter 112. In turn, the Bs determination unit 142 in step S132 acquires the syntax elements supplied from the lossless encoding unit 16.

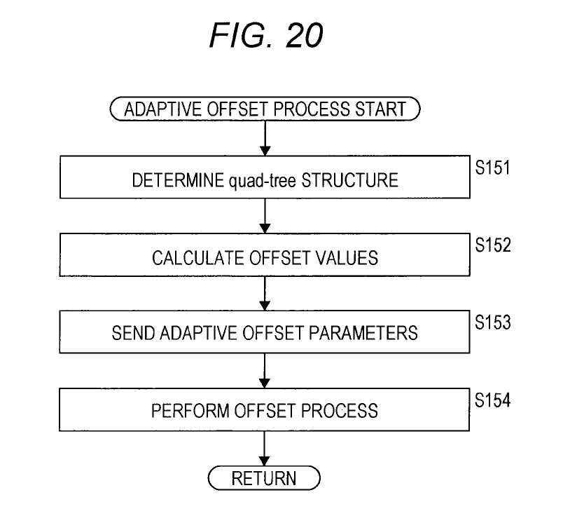

Meanwhile, by the processing in step S111 in FIG. 19, the decoded image (locally-decoded baseband information) from the arithmetic operation unit 20 is supplied to the adaptive offset unit 111. In turn, the adaptive offset unit 111 in step S133 performs an adaptive offset process. This adaptive offset process will be described later with reference to FIG. 20.

By the processing in step S133, the quad-tree structure described above with reference to FIG. 12 is determined, and offset values are calculated for the respective divisional regions by referring to the quad-tree structure. An offset process using the determined quad-tree structure and the offset values is performed on the decoded image from the arithmetic operation unit 20, and the image subjected to the offset process is supplied to the deblocking filter 112.

The information about the determined quad-tree structure is supplied to the deblocking filter control unit 113, and the determined quad-tree structure and the calculated offset values are supplied as adaptive offset parameters to the lossless encoding unit 16.

In step S134, the α/β determination unit 141 and the Bs determination unit 142 determine filter parameters for the deblocking filter 112.

Specifically, the α/β determination unit 141 determines the threshold value α/β based on the quantization parameter indicated by the information acquired in step S131, as described above with reference to FIGS. 7 and 8. The determined threshold value α/β is supplied as a filter parameter to the filter determination unit 143.

Meanwhile, based on the syntax elements (information about a prediction mode and LCU) acquired in step S132, the Bs determination unit 142 determines the value of Bs by the method described above with reference to FIG. 6. Specifically, the Bs determination unit 242 determines the LCU (macroblock) of the prediction mode to which the pixels p or the pixels q shown in FIG. 5 belongs, also determines reference frame information and motion vector information, and then determines the value of Bs based on the results of the motion search/mode determination process.

In step S135, the deblocking filter control unit 113 determines whether the current region in the deblocking filtering process is at an adaptive offset process boundary (or a boundary of the current region in the adaptive offset process). This determination process is performed by referring to the adaptive offset process result (the information about the quad-tree structure) acquired by the processing in step S133.

If the current region in the deblocking filtering process is determined to be at an adaptive offset process boundary in step S135, the process moves on to step S136. In step S136, the deblocking filter control unit 113 adjusts the filter parameter for the deblocking filter 112.

Specifically, the deblocking filter control unit 113 supplies control information for incrementing the Bs value by +1 according to the above described first method, for example, to the Bs determination unit 142. In turn, the Bs determination unit 142 adjusts the filtering strength to increment the Bs value determined in step S134 by +1, and supplies the adjusted Bs value as a filter parameter to the filter determination unit 143.

If the current region in the deblocking filtering process is determined not to be at an adaptive offset process boundary in step S135, the processing in step S136 is skipped. In this case, the Bs determination unit 142 supplies the Bs value determined in step S134 as a filter parameter to the filter determination unit 143.

After the filter parameter is supplied, the filter determination unit 143 determines a filter, and supplies the determined filter and the pixel values that are supplied from the pixel buffer 134, have been subjected to the offset process, and have not been subjected to the deblocking filtering, to the filtering unit 144.

In turn, the filtering unit 144 in step S137 performs a filtering process on the pixel values that are supplied from the filter determination unit 143 and have not been subjected to the deblocking filtering, by using the filter indicated by the filter control information supplied from the filter determination unit 143. The filtering unit 144 supplies the filtered pixel values subjected to the deblocking filtering to the adaptive loop filter 71.

In step S138, the adaptive loop filter 71 performs an adaptive loop filtering process on the image that is supplied from the deblocking filter 112 and has been subjected to the deblocking filtering.

Specifically, the adaptive loop filter 71 calculates an adaptive loop filter coefficient, so as to minimize the residual error in relation to the original image (not shown) from the screen rearrangement buffer 12. Using the calculated adaptive loop filter coefficient, the adaptive loop filter 71 performs a filtering process on the image that is supplied from the deblocking filter 112 and has been subjected to the deblocking filtering.

Although not illustrated in the drawing, the adaptive loop filter 71 sends the calculated adaptive loop filter coefficient to the lossless encoding unit 16. The lossless encoding unit 16 performs a lossless encoding process, such as variable-length encoding or arithmetic encoding, on the adaptive loop filter coefficient, and inserts the adaptive loop filter coefficient into the header portion of the compressed image.

As described above, the adaptive offset process is performed prior to deblocking filtering in the image encoding device 101. Accordingly, block distortion to be caused by the adaptive offset process can be reduced.

Furthermore, in the image encoding device 101, a deblocking filtering process of a higher strength can be performed on a boundary in the adaptive offset process based on the quad-tree structure information that is a result of the adaptive offset process. Accordingly, block distortion can be removed more appropriately, and decoded image quality can be improved.

[Flow of the Adaptive Offset Process]

Referring now to the flowchart shown in FIG. 20, the adaptive offset process in step S134 of FIG. 19 is described.

In step S151, the quad-tree structure determination unit 131 determines the quad-tree structure by referring to the pixel values supplied from the arithmetic operation unit 20, as described above with reference to FIG. 12. Specifically, the quad-tree structure is determined by dividing the image according to the “quad-tree”, and determining, from cost function values, which one of the above described adaptive offset types is to be used for encoding in each of the divisional regions. The information about the determined quad-tree structure is supplied to the offset calculation unit 132 and the offset unit 133.

In step S152, the offset calculation unit 132 calculates the offset value for each region obtained by the quad-tree division with respect to the pixel values supplied from the arithmetic operation unit 20. The information indicating the calculated offset values (offset information) is supplied to the offset unit 133.

In step S153, the adaptive offset unit 111 sends the quad-tree structure and the offsets as adaptive offset parameters to the lossless encoding unit 16. That is, the quad-tree structure determination unit 131 supplies the quad-tree structure information to the lossless encoding unit 16. The offset calculation unit 132 supplies the information about the calculated offsets to the lossless encoding unit 16.

Those adaptive offset parameters are encoded by the lossless encoding unit 16 in step S114 in FIG. 18, and is added to the header information.

In step S154, the offset unit 133 performs an offset process on the pixel values from the arithmetic operation unit 20. Specifically, the offset unit 133 adds the offset values calculated by the offset calculation unit 132, to the pixel values of the respective regions formed through the quad-tree division performed by the quad-tree structure determination unit 131.

The pixel values subjected to the offset values are accumulated in the pixel buffer 134, and are supplied to the filter determination unit 143 of the deblocking filter 112 at a predetermined time.

### 2. SECOND EMBODIMENT

### Image Decoding Device

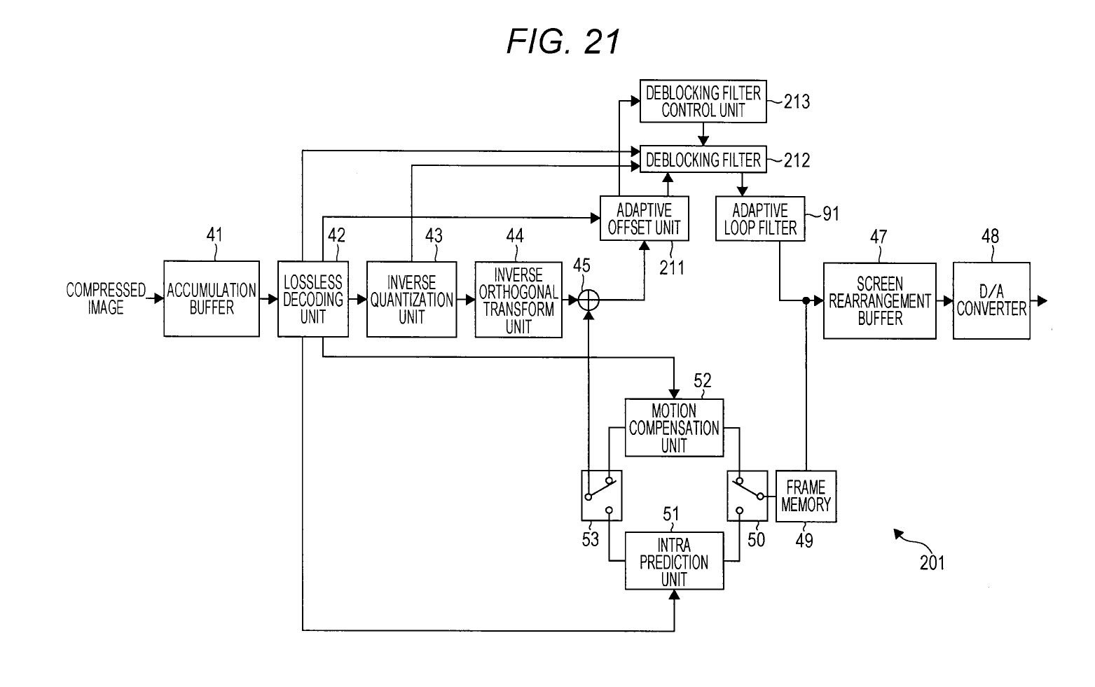

FIG. 21 shows the structure of an embodiment of an image decoding device as an image processing device to which the present disclosure is applied. The image decoding device 201 shown in FIG. 21 is a decoding device that is compatible with the image encoding device 101 shown in FIG. 16.

Data encoded by the image encoding device 101 is transmitted to the image decoding device 201 compatible with the image encoding device 101 via a predetermined transmission path, and is then decoded.

Like the image decoding device 31 shown in FIG. 2, the image decoding device 201 shown in FIG. 21 includes an accumulation buffer 41, a lossless decoding unit 42, an inverse quantization unit 43, an inverse orthogonal transform unit 44, and an arithmetic operation unit 45. Like the image decoding device 31 shown in FIG. 2, the image decoding device 201 shown in FIG. 21 also includes a screen rearrangement buffer 47, a D/A converter 48, a frame memory 49, a selection unit 50, an intra prediction unit 51, a motion compensation unit 52, and an image selection unit 53.

The image decoding device 201 shown in FIG. 21 differs from the image decoding device 31 shown in FIG. 2 in that the adaptive loop filter 91 shown in FIG. 4 is added.

The image decoding device 201 shown in FIG. 21 also differs from the image decoding device 31 shown in FIG. 2 in that the deblocking filter 46 is replaced with a deblocking filter 212, and an adaptive offset unit 211 and a deblocking filter control unit 213 are added.

Specifically, like the lossless decoding unit 42 shown in FIG. 2, the lossless decoding unit 42 decodes information that has been supplied from the accumulation buffer 41 and has been encoded by the lossless encoding unit 16 shown in FIG. 16, by a method compatible with the encoding method used by the lossless encoding unit 16. At this point, motion vector information, reference frame information, prediction mode information (information indicating an intra prediction mode or an inter prediction mode), adaptive offset parameters, and the like are also decoded in the example shown in FIG. 21.

As described above, the adaptive offset parameters are formed with the quad-tree structure information, the offset information, and the like, which are encoded by the lossless encoding unit 16 shown in FIG. 16. The adaptive offset parameters are supplied to the adaptive offset unit 211. The lossless decoding unit 42 also supplies syntax elements such as prediction mode information and motion vector information to the deblocking filter 212.

Like the inverse quantization unit 43 shown in FIG. 2, the inverse quantization unit 43 uses the quantization parameter decoded by the lossless decoding unit 42, to inversely quantize the coefficient data (the quantized coefficient) decoded by the lossless decoding unit 42, by a method compatible with the quantization method used by the quantization unit 15 shown in FIG. 1. In doing so, the inverse quantization unit 43 supplies the information about the quantization parameter to the deblocking filter 212.

The adaptive offset unit 211, the deblocking filter 212 (including the deblocking filter control unit 213), and the adaptive loop filter 91 are placed in this order in the motion compensation loop. The motion compensation loop is the block formed with the arithmetic operation unit 45, the deblocking filter 46, the adaptive loop filter 91, the frame memory 49, the selection unit 50, the motion compensation unit 52, and the image selection unit 53. Hereinafter, filtering processes to be performed by the adaptive offset unit 211, the deblocking filter 212, and the adaptive loop filter 91 in the motion compensation loop will be collectively referred to as the in-loop filtering process.

The quad-tree structure information and the offset information, which are adaptive offset parameters from the lossless decoding unit 42, are supplied to the adaptive offset unit 211. Using those pieces of information, the adaptive offset unit 211 performs an offset process on the pixel values of the decoded image from the arithmetic operation unit 45, and supplies the pixel values subjected to the offset process to the deblocking filter 212. The adaptive offset unit 211 also supplies the quad-tree structure information to the deblocking filter control unit 213.

The deblocking filter 212 receives the quantization parameter of the current region from the inverse quantization unit 43, the syntax elements from the lossless decoding unit 42, and control information from the deblocking filter control unit 213. The deblocking filter 212 determines a filter parameter based on the quantization parameter and the syntax elements. The deblocking filter 212 also adjusts the filtering strength of the determined filter parameter based on the control information from the deblocking filter control unit 213. The deblocking filter 212 determines a filter (filter characteristics) by using the determined or adjusted filter parameter, and performs a deblocking filtering process on the image subjected to the offset process by using the determined filter. The filtered image is supplied to the adaptive loop filter 91.

Based on the information about the quad-tree structure from the adaptive offset unit 211, the deblocking filter control unit 213 determines whether the current region in the deblocking filtering process is at a boundary of the current region in the adaptive offset process. If the current region in the deblocking filtering process is at a boundary of the current region in the adaptive offset process, the deblocking filter control unit 213 supplies control information for increasing the filtering strength to the deblocking filter 212.

Although not illustrated in the drawing, the adaptive loop filter coefficient that is decoded and extracted from the header is supplied from the lossless decoding unit 42 to the adaptive loop filter 91. Using the supplied filter coefficient, the adaptive loop filter 91 performs a filtering process on the decoded image from the deblocking filter 212.

The fundamental operating principles in the adaptive offset unit 211, the deblocking filter 212, and the deblocking filter control unit 213 according to the present technique are the same as those in the adaptive offset unit 111, the deblocking filter 112, and the deblocking filter control unit 113 shown in FIG. 16. In the image encoding device 101 shown in FIG. 16, however, operations of the deblocking filter 112 are controlled by syntax elements such as a prediction mode and motion vector information obtained as a result of a motion search and mode determination, a quantization parameter, and a generated quad-tree structure.

In the image decoding device 201 shown in FIG. 21, on the other hand, the information about those syntax elements, the quantization parameter, and the quad-tree structure is added to encoded data and is sent from the encoding side. Accordingly, in the image decoding device 201, operations of the deblocking filter 212 are controlled by the information about the syntax elements, the quantization parameter, and the quad-tree structure, which is obtained by decoding the above pieces of information.

[Example Structures of the Adaptive Offset Unit and the Deblocking Filter]

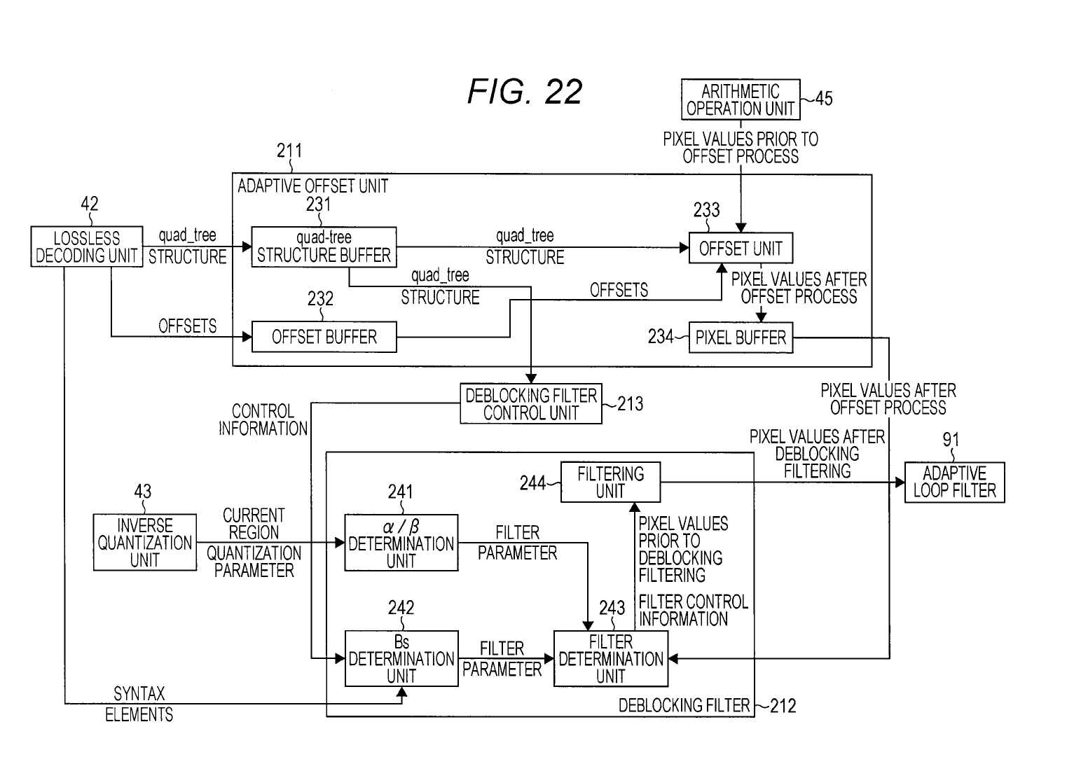

Next, the respective components of the image decoding device 201 are described. FIG. 22 is a block diagram showing example structures of the adaptive offset unit 211 and the deblocking filter 212.

In the example shown in FIG. 22, the adaptive offset unit 211 is designed to include a quad-tree structure buffer 231, an offset buffer 232, an offset unit 233, and a pixel buffer 234.

The deblocking filter 212 is designed to include an a/P determination unit 241, a Bs determination unit 242, a filter determination unit 243, and a filtering unit 244.

The quad-tree structure information from the lossless decoding unit 42 is supplied to the quad-tree structure buffer 231. The quad-tree structure buffer 231 stores the quad-tree structure information from the lossless decoding unit 42, and supplies the quad-tree structure information to the offset unit 233 and the deblocking filter control unit 213.

The offset information from the lossless decoding unit 42 is supplied to the offset buffer 232. The offset buffer 232 stores the offset information from the lossless decoding unit 42, and supplies the offset information to the offset unit 233.

The pixel values that are supplied from the arithmetic operation unit 45 and have not been subjected to an offset process are supplied to the offset unit 233. The offset unit 233 basically has the same structure as the offset unit 133 shown in FIG. 17. The offset unit 233 performs an offset process on the pixel values yet to be subjected to an offset process. Specifically, the offset unit 233 adds the offset values from the offset buffer 232 to the pixel values of the respective regions obtained through quad-tree division performed by the quad-tree structure buffer 231. The offset unit 233 accumulates the pixel values subjected to the offset process in the pixel buffer 234.

The pixel buffer 234 basically has the same structure as the pixel buffer 134 shown in FIG. 17. The pixel buffer 234 accumulates the pixel values subjected to the offset process, and supplies the pixel values subjected to the offset process to the filter determination unit 243 at a predetermined time.

The quantization parameter of the current region in deblocking filtering is supplied from the inverse quantization unit 43 to the α/β determination unit 241. The α/β determination unit 241 basically has the same structure as the α/β determination unit 141 shown in FIG. 17. The α/β determination unit 241 acquires the quantization parameter of the current region in the deblocking filtering process from the inverse quantization unit 43, and, based on the acquired quantization parameter, determines the threshold value α/β as described above with reference to FIGS. 7 and 8. The α/β determination unit 241 supplies the determined threshold value α/β as a filter parameter to the filter determination unit 243.

The syntax elements such as a prediction mode and motion vector information are supplied from the lossless decoding unit 42 to the Bs determination unit 242. The Bs determination unit 242 basically has the same structure as the Bs determination unit 142 shown in FIG. 17. The Bs determination unit 242 acquires the syntax elements related to a prediction mode and LCU from the lossless decoding unit 42. Based on the acquired information, the Bs determination unit 242 determines the value of Bs by the method described above with reference to FIG. 6. When receiving control information from the deblocking filter control unit 213, the Bs determination unit 242 adjusts the value of Bs by the first or second method, whichever is compatible with the method used by the Bs determination unit 142 shown in FIG. 17, in accordance with the control information from the deblocking filter control unit 213. The Bs determination unit 242 supplies the determined or adjusted value of Bs as a filter parameter to the filter determination unit 243.

The filter determination unit 243 basically has the same structure as the filter determination unit 143 shown in FIG. 17. The filter determination unit 243 determines a filter (filter characteristics) from the filter parameters supplied from the α/β determination unit 241 and the Bs determination unit 242, and supplies control information about the determined filter to the filtering unit 244. In doing so, the filter determination unit 243 also supplies the pixel values that are supplied from the pixel buffer 234, have been subjected to the offset process, and have not been subjected to deblocking filtering, to the filtering unit 244.

The filtering unit 244 basically has the same structure as the filtering unit 144 shown in FIG. 17. The filtering unit 244 performs a filtering process on the pixel values that are supplied from the filter determination unit 243 and have not been subjected to deblocking filtering, by using the filter indicated by the filter control information supplied from the filter determination unit 243. The filtering unit 244 supplies the filtered pixel values subjected to the deblocking filtering to the adaptive loop filter 91.

[Flow of a Decoding Process]

Next, the flow of each process to be performed by the above described image decoding device 201 is described. Referring first to the flowchart shown in FIG. 22, an example flow of a decoding process is described.

When the decoding process is started, the accumulation buffer 41 accumulates transmitted encoded data in step S201. In step S202, the lossless decoding unit 42 decodes the encoded data supplied from the accumulation buffer 41. Specifically, I-pictures, P-pictures, and B-pictures encoded by the lossless encoding unit 16 shown in FIG. 16 are decoded.

At this point, motion vector information, reference frame information, prediction mode information (an intra prediction mode or an inter prediction mode), and adaptive offset parameter information are also decoded.

In a case where the prediction mode information is intra prediction mode information, the prediction mode information is supplied to the intra prediction unit 51. In a case where the prediction mode information is inter prediction mode information, the prediction mode information and the corresponding motion vector information are supplied to the motion compensation unit 52 and the deblocking filter 212. The quad-tree structure and offsets that are adaptive offset parameters are supplied to the adaptive offset unit 211.

In step S203, the intra prediction unit 51 or the motion compensation unit 52 performs a predicted image generation process in accordance with the prediction mode information supplied from the lossless decoding unit 42.

Specifically, in a case where intra prediction mode information is supplied from the lossless decoding unit 42, the intra prediction unit 51 generates Most Probable Mode, and generates an intra-predicted image in an intra prediction mode by parallel processing. Ina case where inter prediction mode information is supplied from the loss less decoding unit 42, the motion compensation unit 52 performs a motion prediction/compensation process in an inter prediction mode, and generates an inter-predicted image.

Through this process, the predicted image (the intra-predicted image) generated by the intra prediction unit 51 or the predicted image (the inter-predicted image) generated by the motion compensation unit 52 is supplied to the image selection unit 53.

In step S204, the image selection unit 53 selects a predicted image. Specifically, the predicted image generated by the intra prediction unit 51 or the predicted image generated by the motion compensation unit 52 is supplied. Accordingly, the supplied predicted image is selected and supplied to the arithmetic operation unit 45, and is added to the output of the inverse orthogonal transform unit 44 in the later described step S207.

In the above described step S202, the transform coefficient decoded by the lossless decoding unit 42 is also supplied to the inverse quantization unit 43. In step S205, the inverse quantization unit 43 inversely quantizes the transform coefficient decoded by the lossless decoding unit 42 with the use of the quantization parameter decoded by the lossless decoding unit 42, having the characteristics compatible with the characteristics of the quantization unit 15 shown in FIG. 16. At this point, the inverse quantization unit 43 also supplies the used quantization parameter to the deblocking filter 212.

In step S206, the inverse orthogonal transform unit 44 performs an inverse orthogonal transform on the transform coefficient inversely quantized by the inverse quantization unit 43, having the characteristics compatible with the characteristics of the orthogonal transform unit 14 shown in FIG. 16. As a result, the difference information corresponding to the input to the orthogonal transform unit 14 (or the output from the arithmetic operation unit 13) shown in FIG. 16 is decoded.

In step S207, the arithmetic operation unit 45 adds the difference information to the predicted image that is selected by the above described processing in step S204 and is input via the image selection unit 53. In this manner, the original image is decoded.

In step S208, the adaptive offset unit 211, the deblocking filter 212, the deblocking filter control unit 213, and the adaptive loop filter 91 perform the in-loop filtering process. Through this in-loop filtering process, an adaptive offset process is performed, and ringing and the like are removed.

The filter characteristics of the deblocking filter 212 are determined based not only on the quantization parameter from the inverse quantization unit 43 and the syntax elements from the lossless decoding unit 42 but also on the results (the quad-tree structure information) of the adaptive offset process. A deblocking filtering process in accordance with the determined filter characteristics is then performed on the pixel values subjected to the offset process, to remove block distortion. Further, an adaptive loop filtering process is performed on the pixel values subjected to the deblocking filtering, to improve image quality. The pixel values subjected to the adaptive filtering process are output to the frame memory 49 and the screen rearrangement buffer 47.

In step S209, the frame memory 49 stores the image subjected to the adaptive filtering.

In step S210, the screen rearrangement buffer 47 performs rearrangement on the image after the adaptive loop filter 91. Specifically, the order of frames rearranged for encoding by the screen rearrangement buffer 12 of the image encoding device 101 is rearranged in the original displaying order.

In step S211, the D/A converter 48 performs a D/A conversion on the image supplied from the screen rearrangement buffer 47. The image is output to a display (not shown), and is displayed.

When the processing in step S211 is completed, the decoding process comes to an end.

[Flow of the In-Loop Filtering Process]

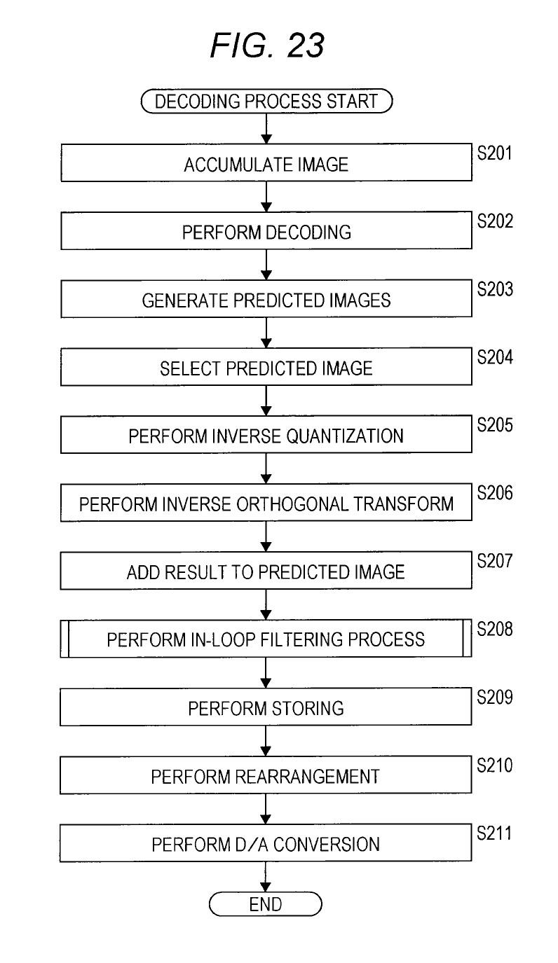

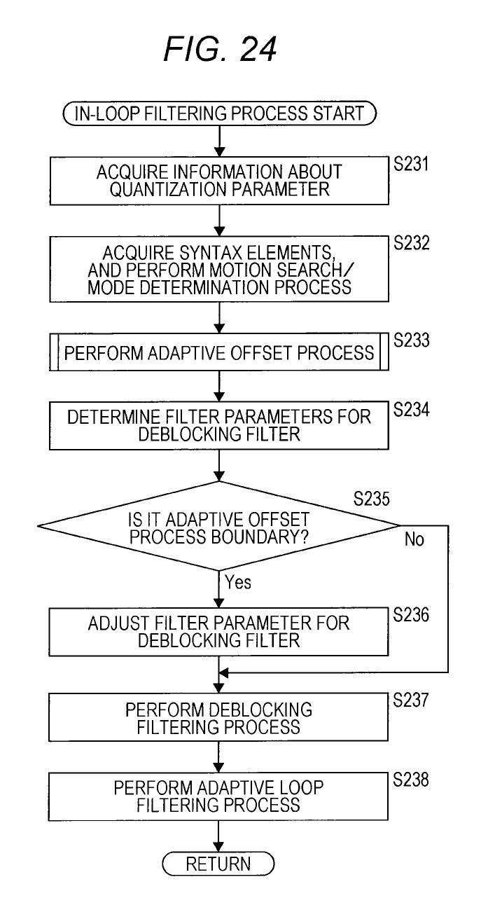

Referring now to the flowchart shown in FIG. 24, an example flow of the in-loop filtering process performed in step S208 in FIG. 23 is described. This in-loop filtering process is a process to be performed by the adaptive offset unit 211, the deblocking filter 212, the deblocking filter control unit 213, and the adaptive loop filter 91.

By the processing in step S205 in FIG. 23, the inverse quantization unit 43 supplies the information about the quantization parameter to the deblocking filter 212. In turn, the α/β determination unit 241 in step S231 acquires the information about the quantization parameter supplied from the inverse quantization unit 43.

By the processing in step S202 in FIG. 23, the lossless decoding unit 42 supplies syntax elements such as the prediction mode information and the motion vector information to the deblocking filter 212. In turn, the Bs determination unit 242 in step S232 acquires the syntax elements supplied from the lossless decoding unit 42, and performs a motion search/mode determination process.

Specifically, the Bs determination unit 242 determines the LCU (macroblock) of the prediction mode to which the pixels p or the pixels q shown in FIG. 5 belongs, and also determines reference frame information and motion vector information, as described above with reference to FIG. 6

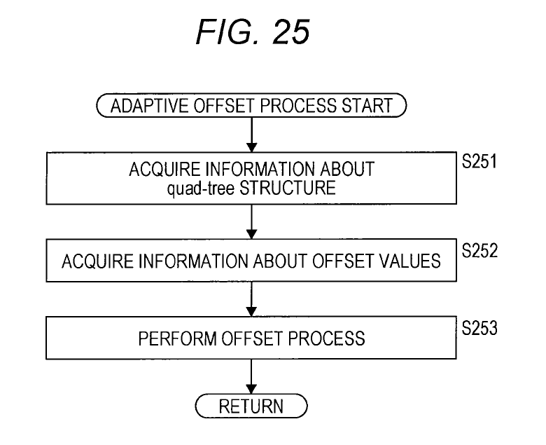

Meanwhile, by the processing in step S207 in FIG. 23, the decoded image (locally-decoded baseband information) from the arithmetic operation unit 45 is supplied to the adaptive offset unit 211. In turn, the adaptive offset unit 211 in step S233 performs an adaptive offset process. This adaptive offset process will be described later with reference to FIG. 25.

By the processing in step S233, the quad-tree structure and the offset values described above with reference to FIG. 12 are acquired from the lossless decoding unit 42. An offset process using the acquired quad-tree structure and offset values is performed on the decoded image from the arithmetic operation unit 45, and the image subjected to the offset process is supplied to the deblocking filter 212.

In step S234, the α/β determination unit 241 and the Bs determination unit 242 determine filter parameters for the deblocking filter 212.

Specifically, the α/β determination unit 241 determines the threshold value α/β based on the quantization parameter acquired in step S232, as described above with reference to FIGS. 7 and 8. The determined threshold value α/β is supplied as a filter parameter to the filter determination unit 243.

Meanwhile, the Bs determination unit 242 determines the value of Bs based on the results of the motion search/mode determination process performed in step S232.

In step S235, the deblocking filter control unit 213 determines whether the current region in the deblocking filtering process is at an adaptive offset process boundary (or a boundary of the current region in the adaptive offset process). This determination process is performed by referring to the adaptive offset process result (the information about the quad-tree structure) acquired by the processing in step S233.

If the current region in the deblocking filtering process is determined to be at an adaptive offset process boundary in step S235, the process moves on to step S236. In step S236, the deblocking filter control unit 213 adjusts the filter parameter for the deblocking filter 212.

Specifically, the deblocking filter control unit 213 supplies control information for incrementing the Bs value by +1 according to the above described first method compatible with the deblocking filter control unit 113 of the image encoding device 101, for example, to the Bs determination unit 242. In turn, the Bs determination unit 242 adjusts the filtering strength to increment the Bs value determined in step S134 by +1, and supplies the adjusted Bs value as a filter parameter to the filter determination unit 243.

If the current region in the deblocking filtering process is determined not to be at an adaptive offset process boundary in step S235, the processing in step S236 is skipped. In this case, the Bs determination unit 242 supplies the Bs value determined in step S234 as a filter parameter to the filter determination unit 243.

After the filter parameter is supplied, the filter determination unit 243 determines (characteristics of) a filter, and supplies the determined filter and the pixel values that are supplied from the pixel buffer 234, have been subjected to the offset process, and have not been subjected to the deblocking filtering, to the filtering unit 244.

In turn, the filtering unit 244 in step S237 performs a filtering process on the pixel values that are supplied from the filter determination unit 243 and have not been subjected to the deblocking filtering, by using the filter indicated by the filter control information supplied from the filter determination unit 243. The filtering unit 244 supplies the filtered pixel values subjected to the deblocking filtering to the adaptive loop filter 91.

In step S238, the adaptive loop filter 91 performs an adaptive loop filtering process on the image that is supplied from the deblocking filter 212 and has been subjected to the deblocking filtering.

Although not illustrated in the drawing, the lossless decoding unit 42 supplies an adaptive loop filter coefficient to the adaptive loop filter 91 by the processing in step S202 in FIG. 23. Using the adaptive loop filter coefficient from the lossless decoding unit 42, the adaptive loop filter 91 performs a filtering process on the image that is supplied from the deblocking filter 212 and has been subjected to the deblocking filtering. The image subjected to the filtering process is supplied to the frame memory 49 and the screen rearrangement buffer 47.

As described above, the adaptive offset process is performed prior to deblocking filtering in the image decoding device 201. Accordingly, block distortion to be caused by the adaptive offset process can be reduced.

Furthermore, in the image decoding device 201, a deblocking filtering process of a higher strength can be performed on a boundary in the adaptive offset process based on the quad-tree structure information that is a result of the adaptive offset process. Accordingly, block distortion can be removed more appropriately, and decoded image quality can be improved.

[Flow of the Adaptive Offset Process]

Referring now to the flowchart shown in FIG. 25, the adaptive offset process in step S233 of FIG. 14 is described.

The quad-tree structure information from the lossless decoding unit 42 is supplied to the quad-tree structure buffer 231. In step S251, the quad-tree structure buffer 231 receives the quad-tree structure information from the lossless decoding unit 42, and stores the quad-tree structure information. The quad-tree structure buffer 231 supplies the quad-tree structure information to the offset unit 233 at a predetermined time.

The offset information from the lossless decoding unit 42 is supplied to the offset buffer 232. In step S252, the offset buffer 232 receives the offset value information from the lossless decoding unit 42, and stores the offset value information. The offset buffer 232 supplies the offset information to the offset unit 233 at a predetermined time.

In step S253, the offset unit 233 performs an offset process on the pixel values subjected to deblocking. Specifically, the offset unit 233 adds the offset values indicated by the information from the offset buffer 232 to the pixel values of the respective regions obtained through quad-tree division performed by the quad-tree structure buffer 231. The offset unit 233 accumulates the pixel values subjected to the offset process in the pixel buffer 234.

The pixel buffer 234 supplies the pixel values subjected to the offset process to the adaptive loop filter 91 at a predetermined time, and the adaptive offset process then comes to an end.

In the above description, the deblocking filter control unit 113 shown in FIG. 16 and the deblocking filter control unit 213 shown in FIG. 21 each generate control information for adjusting the strength of the filter parameter for the deblocking filter, for example. That is, in the above description, information as to how a filter parameter is to be controlled is set beforehand in the deblocking filter control unit 113 shown in FIG. 16 and the deblocking filter control unit 213 shown in FIG. 21.

Alternatively, the control information generated by the deblocking filter control unit 113 of the image encoding device 101 shown in FIG. 16 may be encoded by the lossless encoding unit 16, be added to encoded data, and then be sent to the image decoding device 201. The control information received by the image decoding device 201 may be decoded by the lossless decoding unit 42, and the decoded control information may be used by the deblocking filter control unit 213. At this point, the control information generated by the deblocking filter control unit 113 is encoded for each picture, each sequence, or each slice, for example.

The control information in this case may contain information indicating that an adaptive offset process boundary is determined to be a boundary between regions of different types, a boundary between regions that are of the same type but belong to different categories, or a boundary between regions that are of the same type and belong to the same category. The control information may also contain information indicating that the filtering strength is to be adjusted by the Bs value or the threshold values α and β. The control information may further contain information as to how the Bs value or the threshold values α and β are to be adjusted (the value is to be incremented by +1 or is to be forcibly adjusted to 4, for example). The control information may contain all the above described pieces of information, or may contain at least one of the above described pieces of information while the other pieces of information are set in advance.

Although examples compliant with HEVC have been described above, the present technique can be applied to any device that uses some other encoding method, as long as the device performs the adaptive offset process and the deblocking process within the motion compensation loop.

The present disclosure can be applied to image encoding devices and image decoding devices that are used when image information (bit streams) compressed through orthogonal transforms such as discrete cosine transforms and motion compensation is received via a network medium such as satellite broadcasting, cable television, the Internet, or a portable telephone device, as in MPEG or H.26x, for example. The present disclosure can also be applied to image encoding devices and image decoding devices that are used when compressed image information is processed on a storage medium such as an optical or magnetic disk or a flash memory. Further, the present disclosure can be applied to motion prediction/compensation devices included in such image encoding devices and image decoding devices.

### 3. THIRD EMBODIMENT>

### Computer

The series of processes described above can be performed either by hardware or by software. When the series of processes are to be performed by software, the programs forming the software are installed into a computer. Here, the computer may be a computer incorporated into special-purpose hardware, or may be a general-purpose personal computer that can execute various kinds of functions as various kinds of programs are installed thereinto.

FIG. 24 is a block diagram showing an example structure of the hardware of a computer that performs the above described series of processes in accordance with a program.

In the computer 500, a CPU (Central Processing Unit) 501, a ROM (Read Only Memory) 502, and a RAM (Random Access Memory) 503 are connected to one another by a bus 504.

An input/output interface 505 is further connected to the bus 504. An input unit 506, an output unit 507, a storage unit 508, a communication unit 509, and a drive 510 are connected to the input/output interface 505.

The input unit 506 is formed with a keyboard, a mouse, a microphone, and the like. The output unit 507 is formed with a display, a speaker, and the like. The storage unit 508 is formed with a hard disk, a nonvolatile memory, or the like. The communication unit 509 is formed with a network interface or the like. The drive 510 drives a removable medium 511 such as a magnetic disk, an optical disk, a magnetooptical disk, or a semiconductor memory.

In the computer having the above described structure, the CPU 501 loads a program stored in the storage unit 508 into the RAM 503 via the input/output interface 505 and the bus 504, and executes the program, so that the above described series of operations are performed.

The programs to be executed by the computer 500 (the CPU 501) may be recorded on the removable medium 511 as a package medium to be provided, for example. Alternatively, the programs can be provided via a wired or wireless transmission medium such as a local area network, the Internet, or digital satellite broadcasting.

In the computer, the programs can be installed into the storage unit 508 via the input/output interface 505 when the removable medium 511 is mounted in the drive 510. The programs can also be received by the communication unit 509 via a wired or wireless transmission medium, and be installed into the storage unit 508. Alternatively, the programs may be installed beforehand into the ROM 502 or the storage unit 508.

The programs to be executed by the computer may be programs for performing processes in chronological order in accordance with the sequence described in this specification, or may be programs for performing processes in parallel or performing a process when necessary, such as when there is a call.

In this specification, the steps written in the programs recorded in a recording medium include not only processes to be performed in chronological order in accordance with the sequence described herein, but also processes to be performed in parallel or independently of one another if not necessarily in chronological order.

In this specification, a “system” means an entire apparatus formed with two or more devices (apparatuses).

Also, in the above described examples, any structure described as one device (or one processing unit) may be divided into two or more devices (or processing units). Conversely, any structure described as two or more devices (or processing units) may be combined to form one device (or one processing unit). Also, it is of course possible to add a structure other than the above described ones to the structure of any of the devices (or any of the processing units). Further, as long as the structure and function of the entire system remain the same, part of the structure of a device (or a processing unit) may be incorporated into another device (or another processing unit). That is, embodiments of the present technique are not limited to the above described embodiments, and various modifications may be made to them without departing from the scope of the technique.

The image encoding device and the image decoding device according to the above described embodiments can be applied to various electronic apparatuses including: transmitters and receivers for satellite broadcasting, cable broadcasting such as cable television, deliveries via the Internet, deliveries to terminals by cellular communications, and the like; recording apparatuses that record images on media such as optical disks, magnetic disks, or flash memories; or reproducing apparatuses that reproduce images from those storage media. In the following, four example applications are described.

### 4. EXAMPLE APPLICATIONS

### First Example Application

### Television Receiver

FIG. 25 schematically shows an example structure of a television apparatus to which the above described embodiments are applied. The television apparatus 900 includes an antenna 901, a tuner 902, a demultiplexer 903, a decoder 904, a video signal processing unit 905, a display unit 906, an audio signal processing unit 907, a speaker 908, an external interface 909, a control unit 910, a user interface 911, and a bus 912.

The tuner 902 extracts a signal of a desired channel from broadcast signals received via the antenna 901, and demodulates the extracted signal. The tuner 902 then outputs an encoded bit stream obtained by the demodulation to the demultiplexer 903. That is, the tuner 902 serves as a transmission means in the television apparatus 900 that receives encoded streams formed by encoding images.

The demultiplexer 903 separates the video stream and the audio stream of a show to be viewed from the encoded bit stream, and outputs the respective separated streams to the decoder 904. The demultiplexer 903 also extracts auxiliary data such as an EPG (Electronic Program Guide) from the encoded bit stream, and supplies the extracted data to the control unit 910. In a case where the encoded bit stream has been scrambled, the demultiplexer 903 may perform descrambling.

The decoder 904 decodes the video stream and the audio stream input from the demultiplexer 903. The decoder 904 then outputs the video data generated by the decoding operation to the video signal processing unit 905. The decoder 904 also outputs the audio data generated by the decoding operation to the audio signal processing unit 907.

The video signal processing unit 905 reproduces the video data input from the decoder 904, and causes the display unit 906 to display the video image. Also, the video signal processing unit 905 may cause the display unit 906 to display an application screen supplied via a network. Also, the video signal processing unit 905 may perform additional processing such as denoising on the video data in accordance with the settings. Further, the video signal processing unit 905 may generate an image of a GUI (Graphical User Interface) such as a menu and buttons or a cursor, and superimpose the generated image on an output image.

The display unit 906 is driven by a drive signal supplied from the video signal processing unit 905, and displays a video image or an image on the video screen of a display device (such as a liquid crystal display, a plasma display, or an OELD (Organic ElectroLuminescence Display)).

The audio signal processing unit 907 performs a reproducing operation such as a D/A conversion and amplification on the audio data input from the decoder 904, and outputs sound from the speaker 908. Also, the audio signal processing unit 907 may perform additional processing such as denoising on the audio data.

The external interface 909 is an interface for connecting the television apparatus 900 to an external device or a network. For example, a video stream or an audio stream received via the external interface 909 may be decoded by the decoder 904. That is, the external interface 909 also serves as a transmission means in the television apparatus 900 that receives encoded streams formed by encoding images.

The control unit 910 includes a processor such as a CPU, and a memory such as a RAM or a ROM. The memory stores the program to be executed by the CPU, program data, EPG data, data acquired via networks, and the like. The program stored in the memory is read by the CPU at the time of activation of the television apparatus 900, for example, and is then executed. By executing the program, the CPU controls operations of the television apparatus 900 in accordance with an operating signal input from the user interface 911, for example.

The user interface 911 is connected to the control unit 910. The user interface 911 includes buttons and switches for the user to operate the television apparatus 900, and a reception unit for remote control signals, for example. The user interface 911 generates an operating signal by detecting an operation by the user via those components, and outputs the generated operating signal to the control unit 910.

The bus 912 connects the tuner 902, the demultiplexer 903, the decoder 904, the video signal processing unit 905, the audio signal processing unit 907, the external interface 909, and the control unit 910 to one another.

In the television apparatus 900 having the above described structure, the decoder 904 has the functions of the image decoding device according to the above described embodiments. Accordingly, when images are decoded in the television apparatus 900, block distortion can be removed more appropriately, and decoded image quality can be improved.

### Second Example Application

### Portable Telephone Device

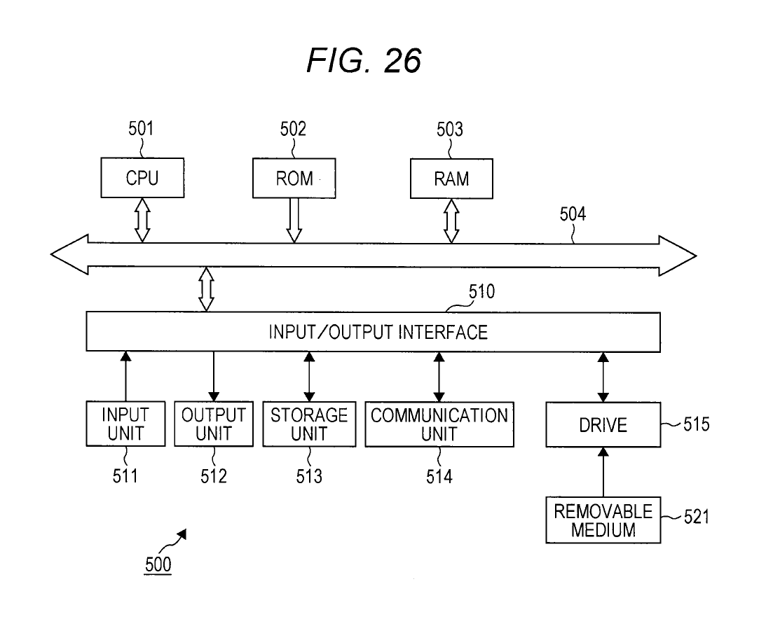

FIG. 26 schematically shows an example structure of a portable telephone device to which the above described embodiments are applied. The portable telephone device 920 includes an antenna 921, a communication unit 922, an audio codec 923, a speaker 924, a microphone 925, a camera unit 926, an image processing unit 927, a multiplexing/separating unit 928, a recording/reproducing unit 929, a display unit 930, a control unit 931, an operation unit 932, and a bus 933.

The antenna 921 is connected to the communication unit 922. The speaker 924 and the microphone 925 are connected to the audio codec 923. The operation unit 932 is connected to the control unit 931. The bus 933 connects the communication unit 922, the audio codec 923, the camera unit 926, the image processing unit 927, the multiplexing/separating unit 928, the recording/reproducing unit 929, the display unit 930, and the control unit 931 to one another.

The portable telephone device 920 performs operations such as transmission and reception of audio signals, transmission and reception of electronic mail or image data, imaging operations, and data recording in various operation modes including an audio communication mode, a data communication mode, an imaging mode, and a video phone mode.

In the audio communication mode, an analog audio signal generated by the microphone 925 is supplied to the audio codec 923. The audio codec 923 converts the analog audio signal to audio data, and performs compression and an A/D conversion on the converted audio data. The audio codec 923 outputs the compressed audio data to the communication unit 922. The communication unit 922 encodes and modulates the audio data, to generate a transmission signal. The communication unit 922 transmits the generated transmission signal to a base station (not shown) via the antenna 921. The communication unit 922 also performs amplification and a frequency conversion on a radio signal received via the antenna 921, and obtains a reception signal. The communication unit 922 generates audio data by demodulating and decoding the reception signal, and outputs the generated audio data to the audio codec 923. The audio codec 923 performs decompression and a D/A conversion on the audio data, to generate an analog audio signal. The audio codec 923 then outputs the generated audio signal to the speaker 924 to output sound.

In the data communication mode, the control unit 931 generates text data constituting an electronic mail in accordance with an operation by the user via the operation unit 932. The control unit 931 causes the display unit 930 to display the text. The control unit 931 also generates electronic mail data in accordance with a transmission instruction from the user via the operation unit 932, and outputs the generated electronic mail data to the communication unit 922. The communication unit 922 encodes and modulates the electronic mail data, to generate a transmission signal. The communication unit 922 transmits the generated transmission signal to a base station (not shown) via the antenna 921. The communication unit 922 also performs amplification and a frequency conversion on a radio signal received via the antenna 921, and obtains a reception signal. The communication unit 922 then restores the electronic mail data by demodulating and decoding the reception signal, and outputs the restored electronic mail data to the control unit 931. The control unit 931 causes the display unit 930 to display the contents of the electronic mail, and stores the electronic mail data into the storage medium in the recording/reproducing unit 929.

The recording/reproducing unit 929 includes a readable/rewritable storage medium. For example, the storage medium may be an internal storage medium such as a RAM or a flash memory, or may be a storage medium of an externally mounted type such as a hard disk, a magnetic disk, a magnetooptical disk, an optical disk, a USB (Unallocated Space Bitmap) memory, or a memory card.

In the imaging mode, the camera unit 926 generates image data by capturing an image of an object, and outputs the generated image data to the image processing unit 927. The image processing unit 927 encodes the image data input from the camera unit 926, and stores the encoded stream into the storage medium in the recording/reproducing unit 929.

In the video phone mode, the multiplexing/separating unit 928 multiplexes a video stream encoded by the image processing unit 927 and an audio stream input from the audio codec 923, and outputs the multiplexed stream to the communication unit 922. The communication unit 922 encodes and modulates the stream, to generate a transmission signal. The communication unit 922 transmits the generated transmission signal to a base station (not shown) via the antenna 921. The communication unit 922 also performs amplification and a frequency conversion on a radio signal received via the antenna 921, and obtains a reception signal. The transmission signal and the reception signal each include an encoded bit stream. The communication unit 922 restores a stream by demodulating and decoding the reception signal, and outputs the restored stream to the multiplexing/separating unit 928. The multiplexing/separating unit 928 separates the video stream and the audio stream from the input stream, and outputs the video stream to the image processing unit 927 and the audio stream to the audio codec 923. The image processing unit 927 decodes the video stream, to generate video data. The video data is supplied to the display unit 930, and a series of images are displayed by the display unit 930. The audio codec 923 performs decompression and a D/A conversion on the audio stream, to generate an analog audio signal. The audio codec 923 then outputs the generated audio signal to the speaker 924 to output sound.

In the portable telephone device 920 having the above described structure, the image processing unit 927 has the functions of the image encoding device and the image decoding device according to the above described embodiments. Accordingly, when images are encoded and decoded in the portable telephone device 920, block distortion can be removed more appropriately, and decoded image quality can be improved.

### Third Example Application

### Recording/Reproducing Apparatus

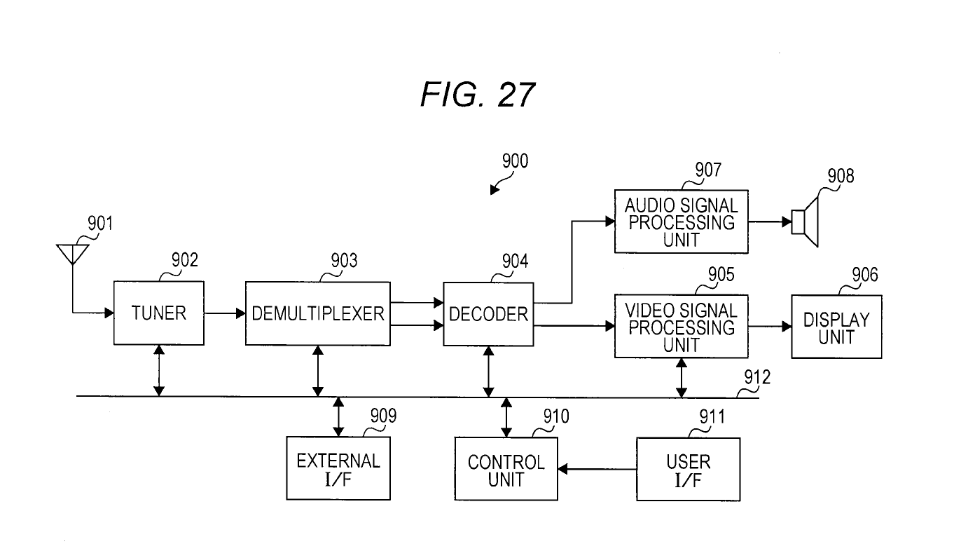

FIG. 27 schematically shows an example structure of a recording/reproducing apparatus to which the above described embodiments are applied. A recording/reproducing apparatus 940 encodes audio data and video data of a received broadcast show, for example, and records the audio data and the video data on a recording medium. The recording/reproducing apparatus 940 may encode audio data and video data acquired from another apparatus, for example, and record the audio data and the video data on the recording medium. The recording/reproducing apparatus 940 also reproduces data recorded on the recording medium through a monitor and a speaker in accordance with an instruction from the user, for example. In doing so, the recording/reproducing apparatus 940 decodes audio data and video data.

The recording/reproducing apparatus 940 includes a tuner 941, an external interface 942, an encoder 943, an HDD (Hard Disk Drive) 944, a disk drive 945, a selector 946, a decoder 947, an OSD (On-Screen Display) 948, a control unit 949, and a user interface 950.

The tuner 941 extracts a signal of a desired channel from broadcast signals received via an antenna (not shown), and demodulates the extracted signal. The tuner 941 outputs the encoded bit stream obtained by the demodulation to the selector 946. That is, the tuner 941 serves as a transmission means in the recording/reproducing apparatus 940.

The external interface 942 is an interface for connecting the recording/reproducing apparatus 940 to an external device or a network. The external interface 942 may be an IEEE1394 interface, a network interface, a USB interface, or a flash memory interface, for example. Video data and audio data received via the external interface 942 are input to the encoder 943, for example. That is, the external interface 942 serves as a transmission means in the recording/reproducing apparatus 940.

In a case where video data and audio data input from the external interface 942 have not been encoded, the encoder 943 encodes the video data and the audio data. The encoder 943 then outputs an encoded bit stream to the selector 946.

The HDD 944 records an encoded bit stream formed by compressing content data such as video images and sound, various programs, and other data on an internal hard disk. At the time of reproduction of video images and sound, the HDD 944 reads those data from the hard disk.

The disk drive 945 records data on and reads data from a recording medium mounted thereon. The recording medium mounted on the disk drive 945 may be a DVD disk (such as a DVD-Video, a DVD-RAM, a DVD-R, a DVD-RW, a DVD+R, or a DVD+RW) or a Blu-ray (a registered trade name) disk, for example.

At the time of recording of video images and sound, the selector 946 selects an encoded bit stream input from the tuner 941 or the encoder 943, and outputs the selected encoded bit stream to the HDD 944 or the disk drive 945. At the time of reproduction of video images and sound, the selector 946 also outputs an encoded bit stream input from the HDD 944 or the disk drive 945, to the decoder 947.

The decoder 947 decodes the encoded bit stream, and generates video data and audio data. The decoder 947 outputs the generated video data to the OSD 948. The decoder 904 also outputs the generated audio data to an external speaker.

The OSD 948 reproduces the video data input from the decoder 947, and displays video images. The OSD 948 may superimpose an image of a GUI such as a menu and buttons or a cursor on the video images to be displayed.

The control unit 949 includes a processor such as a CPU, and a memory such as a RAM or a ROM. The memory stores the program to be executed by the CPU, program data, and the like. The program stored in the memory is read by the CPU at the time of activation of the recording/reproducing apparatus 940, for example, and is then executed. By executing the program, the CPU controls operations of the recording/reproducing apparatus 940 in accordance with an operating signal input from the user interface 950, for example.

The user interface 950 is connected to the control unit 949. The user interface 950 includes buttons and switches for the user to operate the recording/reproducing apparatus 940, and a reception unit for remote control signals, for example. The user interface 950 generates an operating signal by detecting an operation by the user via those components, and outputs the generated operating signal to the control unit 949.

In the recording/reproducing apparatus 940 having the above described structure, the encoder 943 has the functions of the image encoding device according to the above described embodiments. Also, the decoder 947 has the functions of the image decoding device according to the above described embodiments. Accordingly, when images are encoded and decoded in the recording/reproducing apparatus 940, block distortion can be removed more appropriately, and decoded image quality can be improved.

### Fourth Example Application

### Imaging Apparatus

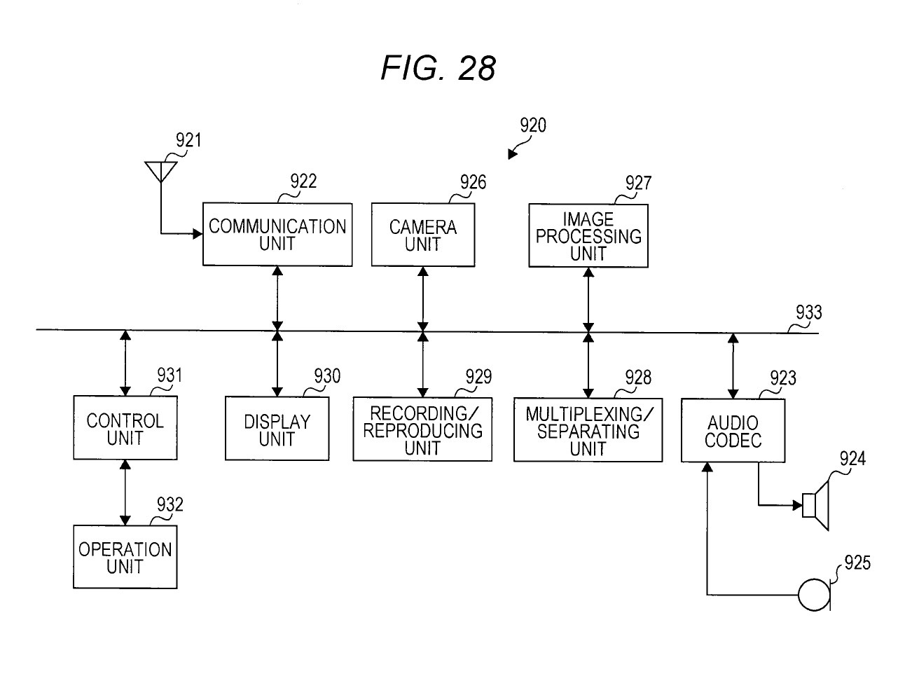

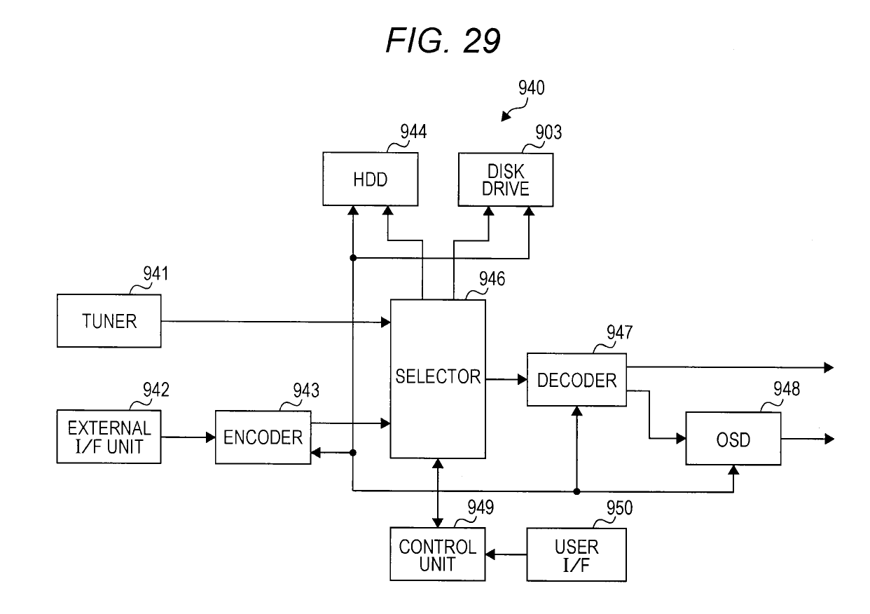

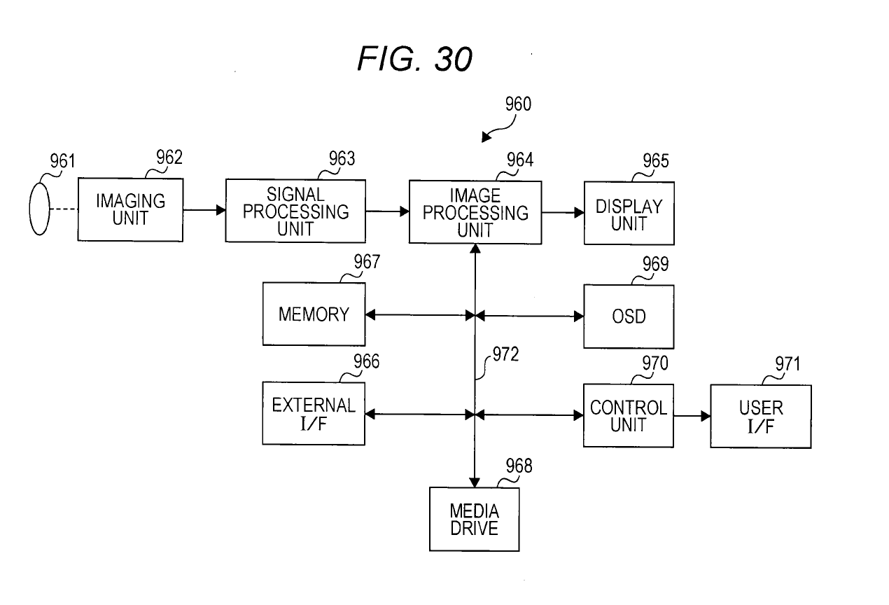

FIG. 28 schematically shows an example structure of an imaging apparatus to which the above described embodiments are applied. An imaging apparatus 960 generates images by imaging an object, encodes the image data, and records the image data on a recording medium.

The imaging apparatus 960 includes an optical block 961, an imaging unit 962, a signal processing unit 963, an image processing unit 964, a display unit 965, an external interface 966, a memory 967, a media drive 968, an OSD 969, a control unit 970, a user interface 971, and a bus 972.

The optical block 961 is connected to the imaging unit 962. The imaging unit 962 is connected to the signal processing unit 963. The display unit 965 is connected to the image processing unit 964. The user interface 971 is connected to the control unit 970. The bus 972 connects the image processing unit 964, the external interface 966, the memory 967, the media drive 968, the OSD 969, and the control unit 970 to one another.

The optical block 961 includes a focus lens and a diaphragm. The optical block 961 forms an optical image of an object on the imaging surface of the imaging unit 962. The imaging unit 962 includes an image sensor such as a CCD (Charge Coupled Device) or a CMOS (Complementary Metal Oxide Semiconductor), and converts the optical image formed on the imaging surface into an image signal as an electrical signal by a photoelectric conversion. The imaging unit 962 outputs the image signal to the signal processing unit 963.

The signal processing unit 963 performs various kinds of camera signal processing such as a knee correction, a gamma correction, and a color correction on the image signal input from the imaging unit 962. The signal processing unit 963 outputs the image data subjected to the camera signal processing to the image processing unit 964.

The image processing unit 964 encodes the image data input from the signal processing unit 963, and generates encoded data. The image processing unit 964 outputs the generated encoded data to the external interface 966 or the media drive 968. The image processing unit 964 also decodes encoded data input from the external interface 966 or the media drive 968, and generates image data. The image processing unit 964 outputs the generated image data to the display unit 965. Alternatively, the image processing unit 964 may output the image data input from the signal processing unit 963 to the display unit 965 to display images. The image processing unit 964 may also superimpose display data acquired from the OSD 969 on the images to be output to the display unit 965.

The OSD 969 generates an image of a GUI such as a menu and buttons or a cursor, for example, and outputs the generated image to the image processing unit 964.

The external interface 966 is formed as a USB input/output terminal, for example. The external interface 966 connects the imaging apparatus 960 to a printer at the time of printing of an image, for example. A drive is also connected to the external interface 966, if necessary. A removable medium such as a magnetic disk or an optical disk is mounted on the drive so that a program read from the removable medium can be installed into the imaging apparatus 960. Further, the external interface 966 may be designed as a network interface to be connected to a network such as a LAN or the Internet. That is, the external interface 966 serves as a transmission means in the imaging apparatus 960.

A recording medium to be mounted on the media drive 968 may be a readable/rewritable removable medium such as a magnetic disk, a magnetooptical disk, an optical disk, or a semiconductor memory. Also, a recording medium may be fixed to the media drive 968, to form a non-portable storage unit such as an internal hard disk drive or an SSD (Solid State Drive).

The control unit 970 includes a processor such as a CPU, and a memory such as a RAM or a ROM. The memory stores the program to be executed by the CPU, program data, and the like. The program stored in the memory is read by the CPU at the time of activation of the imaging apparatus 960, for example, and is then executed. By executing the program, the CPU controls operations of the imaging apparatus 960 in accordance with an operating signal input from the user interface 971, for example.

The user interface 971 is connected to the control unit 970. The user interface 971 includes buttons and switches for the user to operate the imaging apparatus 960, for example. The user interface 971 generates an operating signal by detecting an operation by the user via those components, and outputs the generated operating signal to the control unit 970.

In the imaging apparatus 960 having the above described structure, the image processing unit 964 has the functions of the image encoding device and the image decoding device according to the above described embodiments. Accordingly, when images are encoded and decoded in the imaging apparatus 960, block distortion can be removed more appropriately, and decoded image quality can be improved.

In this specification, various kinds of information such as adaptive offset parameters, and syntax elements like prediction mode information and motion vector information are multiplexed with an encoded stream, and are transmitted from the encoding side to the decoding side, as described so far. However, the method of transmitting the information is not limited to the above example. The information may not be multiplexed with an encoded bit stream, but may be transmitted or recorded as independent data associated with an encoded bit stream. Here, the term “associate” means to link an image (or part of an image, such as a slice or a block) included in a bit stream to the information corresponding to the image at the time of decoding. In other words, the information may be transmitted through a different transmission path from images (orbit streams). Also, the information may be recorded on a different recording medium (or a different recording area in the same recording medium) from images (or bit streams). Further, each piece of the information may be associated with frames, one frame, or part of a frame of images (or bit streams).

Although preferred embodiments of this disclosure have been described above with reference to the accompanying drawings, this disclosure is not limited to those examples. It should be apparent to those who have ordinary skills in the art can make various changes or modifications within the scope of the technical spirit claimed herein, and it is naturally considered that those changes or modifications are within the technical scope of this disclosure.

The present technique can also have the following structures.

(1) An image processing device including:

a decoding unit that decodes an encoded stream to generate an image;

an adaptive offset processing unit that performs an adaptive offset process on the image generated by the decoding unit;

a deblocking filter adjustment unit that adjusts the strength of a deblocking filtering process when the current region in the deblocking filtering process in the image is determined to be at a boundary of the current region in the adaptive offset process based on information about the quad-tree structure used in the adaptive offset process; and

a deblocking filtering unit that performs the deblocking filtering process on the image subj ected to the adaptive offset process by the adaptive offset processing unit, the deblocking filtering process having the strength adjusted by the deblocking filter adjustment unit.

(2) The image processing device of (1), wherein the deblocking filter adjustment unit adjusts the strength of the deblocking filtering process, when the current region in the deblocking filtering process and a neighboring region adjacent to the current region in the deblocking filtering process are at a boundary of the current region in the adaptive offset process, and the current region in the deblocking filtering process and the neighboring region are processed with offsets of different types among edge offsets, band offsets, and “no offset”.

(3) The image processing device of (1) or (2), wherein the deblocking filter adjustment unit adjusts the strength of the deblocking filtering process, when the current region in the deblocking filtering process and a neighboring region adjacent to the current region in the deblocking filtering process are at a boundary of the current region in the adaptive offset process, and are processed with offsets of the same type and under different categories, the type of the offsets being an edge offset or a band offset.

(4) The image processing device of any of (1) through (3), wherein the deblocking filter adjustment unit adjusts the strength of the deblocking filtering process with a boundary strength value.

(5) The image processing device of (4), wherein the deblocking filter adjustment unit adjusts the strength of the deblocking filtering process by incrementing the boundary strength value by +1, when the current region in the deblocking filtering process and the neighboring region are at a boundary of the current region in the adaptive offset process and are processed with offsets of different types.

(6) The image processing device of (4), wherein the deblocking filter adjustment unit adjusts the strength of the deblocking filtering process by adjusting the boundary strength value to 4, when the current region in the deblocking filtering process and the neighboring region are at a boundary of the current region in the adaptive offset process and are processed with offsets of different types.

(7) The image processing device of any of (1) through (3), wherein the deblocking filter adjustment unit adjusts the strength of the deblocking filtering process with a value α or a value β, when the current region in the deblocking filtering process and the neighboring region are at a boundary of the current region in the adaptive offset process and are processed with offsets of different types.

(8) The image processing device of (7), wherein the deblocking filter adjustment unit determines the value a or the value β by performing table reduction using a value obtained by adding a quantization parameter QP and a predetermined value ΔQP, when the current region in the deblocking filtering process and the neighboring region are at a boundary of the current region in the adaptive offset process and are processed with offsets of different types.

(9) An image processing method including:

generating an image by decoding an encoded stream;

performing an adaptive offset process on the generated image;

adjusting the strength of a deblocking filtering process when the current region in the deblocking filtering process in the image is determined to be a boundary of the current region in the adaptive offset process based on information about the quad-tree structure used in the adaptive offset process; and

performing the deblocking filtering process on the image subjected to the adaptive offset process, the deblocking filtering process having the adjusted strength,

an image processing device generating the image, performing the adaptive offset process, adjusting the strength of the deblocking filtering process, and performing the deblocking filtering process.

(10) An image processing device including:

an adaptive offset processing unit that performs an adaptive offset process on an image that is locally decoded at a time of image encoding;

a deblocking filter adjustment unit that adjusts the strength of a deblocking filtering process when the current region in the deblocking filtering process in the image is determined to be a boundary of the current region in the adaptive offset process based on information about the quad-tree structure used in the adaptive offset process;

a deblocking filtering unit that performs the deblocking filtering process on the image subjected to the adaptive offset process by the adaptive offset processing unit, the deblocking filtering process having the strength adjusted by the deblocking filter adjustment unit; and

an encoding unit that encodes the image by using the image subjected to the deblocking filtering process by the deblocking filtering unit.

(11) The image processing device of (10), wherein the deblocking filter adjustment unit adjusts the strength of the deblocking filtering process, when the current region in the deblocking filtering process and a neighboring region adjacent to the current region in the deblocking filtering process are at a boundary of the current region in the adaptive offset process, and the current region in the deblocking filtering process and the neighboring region are processed with offsets of different types among edge offsets, band offsets, and “no offset”.

(12) The image processing device of (10) or (11), wherein the deblocking filter adjustment unit adjusts the strength of the deblocking filtering process, when the current region in the deblocking filtering process and a neighboring region adjacent to the current region in the deblocking filtering process are at a boundary of the current region in the adaptive offset process, and are processed with offsets of the same type and under different categories, the type of the offsets being an edge offset or a band offset.

(13) The image processing device of any of (10) through (12), wherein the deblocking filter adjustment unit adjusts the strength of the deblocking filtering process with a boundary strength value.

(14) The image processing device of (13), wherein the deblocking filter adjustment unit adjusts the strength of the deblocking filtering process by incrementing the boundary strength value by +1, when the current region in the deblocking filtering process and the neighboring region are at a boundary of the current region in the adaptive offset process and are processed with offsets of different types.

(15) The image processing device of (13), wherein the deblocking filter adjustment unit adjusts the strength of the deblocking filtering process by adjusting the boundary strength value to 4, when the current region in the deblocking filtering process and the neighboring region are at a boundary of the current region in the adaptive offset process and are processed with offsets of different types.

(16) The image processing device of any of (10) through (12), wherein the deblocking filter adjustment unit adjusts the strength of the deblocking filtering process with a value α or a value β, when the current region in the deblocking filtering process and the neighboring region are at a boundary of the current region in the adaptive offset process and are processed with offsets of different types.

(17) The image processing device of (16), wherein the deblocking filter adjustment unit determines the value α or the value β by performing table reduction using a value obtained by adding a quantization parameter QP and a predetermined value ΔQP, when the current region in the deblocking filtering process and the neighboring region are at a boundary of the current region in the adaptive offset process and are processed with offsets of different types.

(18) An image processing method including:

performing an adaptive offset process on an image that is locally decoded at a time of image encoding;

adjusting the strength of a deblocking filtering process when the current region in the deblocking filtering process in the image is determined to be a boundary of the current region in the adaptive offset process based on information about the quad-tree structure used in the adaptive offset process;

performing the deblocking filtering process on the image subjected to the adaptive offset process, the deblocking filtering process having the adjusted strength; and

encoding the image by using the image subjected to the deblocking filtering process,

an image processing device performing the adaptive offset process, adjusting the strength of the deblocking filtering process, performing the deblocking filtering process, and encoding the image.

### REFERENCE SIGNS LIST

15 Quantization unit
16 Lossless encoding unit
42 Lossless decoding unit
43 Inverse quantization unit
71 Adaptive loop filter
91 Adaptive loop filter
101 Image encoding device
111 Adaptive offset unit
112 Deblocking filter
113 Deblocking filter control unit
131 Quad-tree structure determination unit
132 Offset calculation unit
133 Offset unit
134 Pixel buffer
141 α/β determination unit
142 Bs determination unit
143 Filter determination unit
144 Filtering unit
201 image decoding device
211 Adaptive offset unit
212 Deblocking filter
213 Deblocking filter control unit
231 Quad-tree structure buffer
232 Offset buffer
233 Offset unit
234 Pixel buffer
241 α/β determination unit
242 Bs determination unit
243 Filter determination unit
244 Filtering unit

1. An image processing device comprising:
a decoding unit configured to decode an encoded stream to generate an image;
an adaptive offset processing unit configured to perform an adaptive offset process on the image generated by the decoding unit;
a deblocking filter adjustment unit configured to adjust strength of a deblocking filtering process when a current region in the deblocking filtering process in the image is determined to be a boundary of the current region in the adaptive offset process based on information about a quad-tree structure used in the adaptive offset process; and
a deblocking filtering unit configured to perform the deblocking filtering process on the image subjected to the adaptive offset process by the adaptive offset processing unit, the deblocking filtering process having the strength adjusted by the deblocking filter adjustment unit.

2. The image processing device according to claim 1, wherein the deblocking filter adjustment unit adjusts the strength of the deblocking filtering process, when the current region in the deblocking filtering process and a neighboring region adjacent to the current region in the deblocking filtering process are at a boundary of the current region in the adaptive offset process, and the current region in the deblocking filtering process and the neighboring region are processed with offsets of different types among edge offsets, band offsets, and “no offset”.

3. The image processing device according to claim 2, wherein the deblocking filter adjustment unit adjusts the strength of the deblocking filtering process, when the current region in the deblocking filtering process and the neighboring region adjacent to the current region in the deblocking filtering process are at a boundary of the current region in the adaptive offset process, and are processed with offsets of the same type and under different categories, the type of the offsets being an edge offset or a band offset.

4. The image processing device according to claim 2, wherein the deblocking filter adjustment unit adjusts the strength of the deblocking filtering process with a boundary strength value.

5. The image processing device according to claim 4, wherein the deblocking filter adjustment unit adjusts the strength of the deblocking filtering process by incrementing the boundary strength value by +1, when the current region in the deblocking filtering process and the neighboring region are at a boundary of the current region in the adaptive offset process and are processed with offsets of different types.

6. The image processing device according to claim 4, wherein the deblocking filter adjustment unit adjusts the strength of the deblocking filtering process by adjusting the boundary strength value to 4, when the current region in the deblocking filtering process and the neighboring region are at a boundary of the current region in the adaptive offset process and are processed with offsets of different types.

7. The image processing device according to claim 2, wherein the deblocking filter adjustment unit adjusts the strength of the deblocking filtering process with a value α or a value β, when the current region in the deblocking filtering process and the neighboring region are at a boundary of the current region in the adaptive offset process and are processed with offsets of different types.

8. The image processing device according to claim 7, wherein the deblocking filter adjustment unit determines the value α or the value β by performing table reduction using a value obtained by adding a quantization parameter QP and a predetermined value ΔQP, when the current region in the deblocking filtering process and the neighboring region are at a boundary of the current region in the adaptive offset process and are processed with offsets of different types.

9. An image processing method comprising:
generating an image by decoding an encoded stream;
performing an adaptive offset process on the generated image;
adjusting strength of a deblocking filtering process when a current region in the deblocking filtering process in the image is determined to be a boundary of the current region in the adaptive offset process based on information about a quad-tree structure used in the adaptive offset process; and
performing the deblocking filtering process on the image subjected to the adaptive offset process, the deblocking filtering process having the adjusted strength,
an image processing device generating the image, performing the adaptive offset process, adjusting the strength of the deblocking filtering process, and performing the deblocking filtering process.

10. An image processing device comprising:
an adaptive offset processing unit configured to perform an adaptive offset process on an image that is locally decoded at a time of image encoding;
a deblocking filter adjustment unit configured to adjust strength of a deblocking filtering process when a current region in the deblocking filtering process in the image is determined to be a boundary of the current region in the adaptive offset process based on information about a quad-tree structure used in the adaptive offset process;
a deblocking filtering unit configured to perform the deblocking filtering process on the image subjected to the adaptive offset process by the adaptive offset processing unit, the deblocking filtering process having the strength adjusted by the deblocking filter adjustment unit; and
an encoding unit configured to encode the image by using the image subjected to the deblocking filtering process by the deblocking filtering unit.

11. The image processing device according to claim 10, wherein the deblocking filter adjustment unit adjusts the strength of the deblocking filtering process, when the current region in the deblocking filtering process and a neighboring region adjacent to the current region in the deblocking filtering process are at a boundary of the current region in the adaptive offset process, and the current region in the deblocking filtering process and the neighboring region are processed with offsets of different types among edge offsets, band offsets, and “no offset”.

12. The image processing device according to claim 11, wherein the deblocking filter adjustment unit adjusts the strength of the deblocking filtering process, when the current region in the deblocking filtering process and the neighboring region adjacent to the current region in the deblocking filtering process are at a boundary of the current region in the adaptive offset process, and are processed with offsets of the same type and under different categories, the type of the offsets being an edge offset or a band offset.

13. The image processing device according to claim 11, wherein the deblocking filter adjustment unit adjusts the strength of the deblocking filtering process with a boundary strength value.

14. The image processing device according to claim 13, wherein the deblocking filter adjustment unit adjusts the strength of the deblocking filtering process by incrementing the boundary strength value by +1, when the current region in the deblocking filtering process and the neighboring region are at a boundary of the current region in the adaptive offset process and are processed with offsets of different types.

15. The image processing device according to claim 13, wherein the deblocking filter adjustment unit adjusts the strength of the deblocking filtering process by adjusting the boundary strength value to 4, when the current region in the deblocking filtering process and the neighboring region are at a boundary of the current region in the adaptive offset process and are processed with offsets of different types.

16. The image processing device according to claim 11, wherein the deblocking filter adjustment unit adjusts the strength of the deblocking filtering process with a value α or a value β, when the current region in the deblocking filtering process and the neighboring region are at a boundary of the current region in the adaptive offset process and are processed with offsets of different types.

17. The image processing device according to claim 16, wherein the deblocking filter adjustment unit determines the value α or the value β by performing table reduction using a value obtained by adding a quantization parameter QP and a predetermined value ΔQP, when the current region in the deblocking filtering process and the neighboring region are at a boundary of the current region in the adaptive offset process and are processed with offsets of different types.

18. An image processing method comprising:
performing an adaptive offset process on an image that is locally decoded at a time of image encoding;
adjusting strength of a deblocking filtering process when a current region in the deblocking filtering process in the image is determined to be a boundary of the current region in the adaptive offset process based on information about a quad-tree structure used in the adaptive offset process;
performing the deblocking filtering process on the image subjected to the adaptive offset process, the deblocking filtering process having the adjusted strength; and
encoding the image by using the image subjected to the deblocking filtering process,
an image processing device performing the adaptive offset process, adjusting the strength of the deblocking filtering process, performing the deblocking filtering process, and encoding the image.
